(19) United States
(12) Patent Application Publication
(10) Pub. No.: US 2026/0052132 A1
(43) Pub. Date: Feb. 19, 2026

(54) CRYPTOGRAPHIC TRANSMISSION TECHNIQUES

(71) Applicant: 1Money Co., New York, NY (US)

(72) Inventors: Christoph Siebenbrunner, Guntramdorf (AT); Laurent Bindschaedler, Saarbrucken (DE); Brian Walker Shroder, Incline Village, NV (US)

(73) Assignee: 1Money Co., New York, NY (US)

(21) Appl. No.: 19/368,921

(22) Filed: Oct. 24, 2025

Related U.S. Application Data
(63) Continuation of application No. 18/891,538, filed on Sep. 20, 2024.
Application No. 18/891,538 is a continuation-in-part of application No. 18/648,613, filed on Apr. 29, 2024.
(60) Provisional application No. 63/539,782, filed on Sep. 21, 2023.
(60) Provisional application No. 63/539,782, filed on Sep. 21, 2023.

(51) Int. Cl. H04L 9/40

(52) U.S. Cl. CPC H04L 63/0428; H04L 63/123

(57) ABSTRACT

Described herein are techniques for cryptographically securing transmissions from senders to recipients using a network of validation units. The network of validation units receives a request for a transmission. Validation units in the network of validation units validate the transmission and cryptographically sign and transmit a message when they determine that the transmission is valid. When a threshold number of validation signatures are transmitted by the network of validation units, the transmission may be executed.

### CROSS REFERENCE TO PRIOR APPLICATIONS

This is application claims the benefit of and priority under 35 U.S.C. § 120 as a continuation application of U.S. application Ser. No. 18/891,538, entitled “CRYPTOGRAPHIC TRANSMISSION TECHNIQUES,” filed on Sep. 20, 2024, which claims the benefit under 35 U.S.C § 120 as a continuation-in-part of U.S. application Ser. No. 18/648,613, entitled “BYZANTINE FAULT TOLERANCE FOR INSTANT PAYMENT AND METHODS OF PERFORMING THE SAME” filed Apr. 29, 2024, which claims the benefit under 35 U.S.C. § 119(e) of U.S. application Ser. No. 63/539,782, entitled “BYZANTINE FAULT TOLERANCE FOR INSTANT PAYMENT AND METHODS OF PERFORMING THE SAME” filed Sep. 21, 2023. application Ser. No. 18/891,583 also claims the benefit under 35 U.S.C. § 119(e) of U.S. application Ser. No. 63/539,782, entitled “BYZANTINE FAULT TOLERANCE FOR INSTANT PAYMENT AND METHODS OF PERFORMING THE SAME” filed Sep. 21, 2023, each of which is fully incorporated herein by reference.

### BACKGROUND OF THE INVENTION

Digital transactions are growing as a method of conducting business between two or more parties. However, due to the nature of digital transactions, no tangible items are used in the transaction. This presents numerous problems including verifying the different aspects of a transaction, initiating payments and the prevention of fraud. In addition, digital transactions can utilize large amounts of processor power, which can further delay the execution of a transaction.

A need exists for a system that will expedite the progression of a transaction without compromising the security of the transaction or utilizing large amount of processing power.

### SUMMARY OF THE INVENTION

A cryptographic transmission system (e.g., implemented as a Layer 1 (L1)) may be a Byzantine-fault tolerant protocol with sybil protection (e.g. proof-of-stake or proof-of-authority, i.e. permissioned validators) and incentive compatibility mechanisms for validators (e.g. share of transaction fees, money generation) that is used for confirming payment transactions. Some embodiments may use a blockchain such as Ethereum (with smart contracts disabled). Some embodiments may use a broadcast-based transmission system. A unified transmission medium may be used as a medium in which to distribute transmission fees (e.g., as a native gas token) and to represent amounts of resources belonging to users. In some embodiments, each user may have multiple balances of the unified transmission medium, and transmission fees would always be charged in the corresponding currency.

It allows users to hold multiple resources (e.g., currencies) in the same cryptographic transmission system. This becomes particularly interesting when it is coupled with an exchange mechanism between resources (e.g., with atomic settlement). Being able to transmit multiple resources is interesting for a variety of reasons, and it becomes even more interesting when you consider that a resource does not need to refer to fiat currencies but could also refer to any asset.

Conventional cryptographic transmission systems may be based on cryptocurrencies, i.e. a newly created asset with no intrinsic value other than being used to pay transmission fees. Offering multiple resource transmission would be a detraction from the core value proposition of their cryptocurrency, because they would have to justify the value of multiple assets. Some embodiments use a stablecoin-based cryptographic transmission system, where the intrinsic value of the transmission medium is independent of the cryptographic transmission system. Some embodiments may provide the ability to execute smart contracts as part of the core value proposition as well. The execution itself may not have anything to do with the unified transmission medium. In such situations, offering multiple resources (e.g., gas tokens) would create arbitrage opportunities, as users could choose the transmission where transmission fees have the currently lowest real-word value.

Some embodiments use a centralized design where a central operator registers the available amounts of a unified transmission medium. For each resource a system with authority to create new amounts of the unified transmission medium, and/or a set of rules governing how additional amounts of the unified transmission medium may be issued (e.g. following confirmation of a proof-of-ownership). The set of resources may be indicated by a governance parameter and can be changed in governance parameter updates.

Each transmission may specify the resource to be used, and validators check the balance of the unified transmission medium representing the resource. Some embodiments may use an L1 that uses an account model (e.g., Ethereum) instead of UTXOs (e.g., as in Bitcoin). In the account model, each user account has a nonce, i.e. a (strictly increasing) transmission counter. There could be one nonce for all resources or one nonce per resource (multiple embodiments). Multiple nonces may allow parallel processing of transmissions of different resources.

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a payment management system having a payment management unit that initiates a transaction, an operation unit that manages the issuance of at least one certificate, a governance unit that operates based on at least one parameter defined in the at least one certificate, at least one validation unit that receives the at least one certificate and validates portions of the transaction, and a payment unit that issues payment based on the terms of the at least one certificate where the operation unit crates a governance protocol for each transaction with the governance protocol including at least one epoch and at least one checkpoint.

In another embodiment, the at least one epoch is created by an epoch transition.

In another embodiment, the at least one epoch is associated with a governance certificate generated from the governance unit.

In another embodiment, each checkpoint is created by the at least one validation unit to represent the completion of a task.

In another embodiment, an epoch transition is created when a checkpoint changes a validation parameter.

Another embodiment includes a nonce associated with each transaction.

In another embodiment, the certificate is broadcast to the at least one validation unit over a network.

In another embodiment, at least one checkpoint includes a transaction array listing all the events associated with a transaction.

In another embodiment, a checkpoint proposal is broadcast to selected validation units for acceptance.

In another embodiment, the checkpoint proposal is validated using Byzantine Fault Tolerance.

Another embodiment includes a method of making payments for a transaction including the steps of initiating a transaction via a payment management unit, managing the issuance of at least one certificate via an operation unit, a governance unit based on at least one parameter defined in the at least one certificate, receiving the at least one certificate and validating portions of the transaction via at least one validation unit, issuing a payment based on the terms of the at least one certificate via a payment unit, and creating a governance protocol for each transaction via the governance unit with the governance protocol including at least one epoch and at least one checkpoint.

In another embodiment, the at least one epoch is created by an epoch transition.

Another embodiment includes the step of associating the at least one epoch with a governance certificate generated from the governance unit.

In another embodiment, each checkpoint is created by the at least one validation unit to represent the completion of a task.

Another embodiment includes the step of creating the epoch transition when a checkpoint changes a validation parameter.

Another embodiment includes the step of associating a nonce with each transaction.

Another embodiment includes the step of broadcasting the certificate to the at least one validation unit over a network.

In another embodiment at least one checkpoint includes a transaction array listing all the events associated with a transaction.

Another embodiment includes the step of broadcasting a checkpoint proposal to selected validation units for acceptance.

Another embodiment includes the step of validating the checkpoint proposal is validated using Byzantine Fault Tolerance.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a payment management system 100 consistent with the present invention, according to some embodiments of the technology described herein.

FIG. 2 depicts one embodiment of a payment management unit, according to some embodiments of the technology described herein.

FIG. 3 depicts one embodiment of a communication device 104/106 consistent with the present invention, according to some embodiments of the technology described herein.

FIG. 4 depicts a schematic representation of the broadcast system for the payment management system, according to some embodiments of the technology described herein.

FIG. 5 depicts a schematic representation of a system of processing a payment request, according to some embodiments of the technology described herein.

FIG. 6 depicts the schematic representation of a recovery process, according to some embodiments of the technology described herein.

FIG. 7 is a schematic representation of a payment transaction, according to some embodiments of the technology described herein.

FIG. 8 depicts the schematic representation of a checkpoint creation process, according to some embodiments of the technology described herein.

FIG. 9 depicts a schematic representation of a process for creating a governance certificate, according to some embodiments of the technology described herein.

FIG. 10 is a schematic representation of a payment system, according to some embodiments of the technology described herein.

FIG. 11 depicts a schematic representation of a ledger system, according to some embodiments of the technology described herein.

FIG. 12 depicts a schematic representation of a minting process for a token, according to some embodiments of the technology described herein.

FIG. 13 depicts a schematic representation of a settlement process, according to some embodiments of the technology described herein.

FIG. 14A depicts an example validator (also referred to herein as a “validation unit”) of a cryptographic transmission system for transmission of multiple different resources, according to some embodiments of the technology described herein.

FIG. 14B depicts an example validation of a requested transmission in a cryptographic transmission system comprising a network of validators configured as depicted in FIG. 14A, according to some embodiments of the technology described herein.

FIG. 14C depicts operation of a validator in validating the requested transmission of FIG. 14B, according to some embodiments of the technology described herein.

FIG. 15 depicts the issuance of a uniform transmission medium to users of a cryptographic transmission system, according to some embodiments of the technology described herein.

FIG. 16 depicts an example process for transmitting one or more resources using a cryptographic transmission system, according to some embodiments of the technology described herein.

FIG. 17 is an example computer system that may be specially configured to perform embodiments of the technology described herein.

### DETAILED DESCRIPTION OF THE INVENTION

Described herein is a cryptographic transmission system and associated techniques for transmission of resources. The cryptographic transmission system is a broadcast-based system in which transmission requests are asynchronously validated by a network of validation units.

The inventors have developed a cryptographic transmission system that can validate a transmission more quickly than conventional systems that rely on consensus among validators while offering the same level of security guarantees. Techniques described herein may provide Byzantine fault tolerance (BFT) without needing validators to reach a full consensus. For example, the cryptographic transmission system may finalize 100,000 transmissions per second at 100 ms latency until finality.

Consensus-based validation in transmission systems requires that, for each transmission, a consensus is reached among validators to determine the validity of the transmission. The consensus provides a high level of decentralized security and reliability for transmission validation and recording. However, consensus among validation units involves long processing times due to the communication and coordination needed to reach consensus. For example, the commonly used proof-of-work and proof-of-stake algorithms require long processing times to achieve consensus among a set of validators. Conventional systems may also apply ordering to transmissions, which further lengthens processing times for validation.

The inventors have developed a cryptographic transmission system that does not rely on consensus to achieve BFT. Additionally, the system does not apply ordering to transmissions. This allows the system to achieve finality faster than consensus-based systems while providing equivalent levels of cryptographic security. The cryptographic transmission system validates transmissions without needing validation units to communicate and coordinate with each other (as required for consensus). The cryptographic transmission system employs an asynchronous validation technique in which a message requesting a transmission is broadcast to a network of validators. Each validator performs validation independently of the other validators. For example, in some embodiments, as soon as a threshold number of validation units have communicated that the transmission is valid, the transmission may be executed. The system does not require any staking, slashing, or proof-of-work. Further, the system does not involve the ordering of transmissions. This allows the system to validate a transmission with a single broadcast to the network of validation units and eliminates the need for the network of validation units to communicate with one another to determine an ordering of transmissions.

The cryptographic transmission system may utilize a unified transmission medium (UTM) to transmit resources between users. The UTM may be data stored in memory that provides a digital representation of a resource belonging to a user. The cryptographic transmission system may store balances of the UTM for the users. A UTM balance of a user may represent an amount of a particular resource (e.g., currency, financial instrument, fungible goods, or other resource) that belongs to the user. For example, the UTM used by the cryptographic transmission system may be a digital token. Tokens may be issued to a user to represent an amount of a resource belonging to the user. For example, the cryptographic transmission system may receive, from an external system, an amount of a resource belonging to the user. The cryptographic transmission system may issue a corresponding amount of the UTM to the user that can be used to transmit amounts of the resource to other users. The UTM used by the cryptographic transmission system may not have inherit value, unlike cryptocurrencies such as Bitcoin. Rather, the UTM is used by the cryptographic transmission system as an electronic representation of a resource that enables efficient and secure transmission of the resource through the cryptographic transmission system.

The cryptographic transmission system may include a network of validators (also referred to as “validation units”) that each store users'UTM balances. The network of validation units may validate transmissions. When a transmission is validated by the network of validation units (e.g., when a threshold number of validation units have determined that the transmission is valid or when the network of validation units has reached a consensus that the transmission is valid), the transmission may be executed in the cryptographic transmission system. Execution of the transmission may involve the network of validation units updating their respective memories to reflect the transmission of an amount of a UTM from the user to the recipient(s).

The inventors have recognized that conventional cryptographic transmission systems that utilize a unified transmission medium cannot be used to transmit multiple different resources. Firstly, conventional systems rely on a cryptocurrency in which transmission fees (also referred to as “gas fees”) are paid. Conventional systems typically do not include multiple resource transmission capabilities because having resources in addition to the native cryptocurrency of the systems would detract from use of the cryptocurrency. Conventional systems that do have multiple resource transmissions utilize multiple separate chains that operate independently of one another.

Accordingly, described herein are embodiments of a cryptographic transmission system configured to securely transmit multiple different resources that may belong to users of the system. The cryptographic transmission system may use the UTM to transmit different types of resources. The network of validation units may store, for each of multiple users of the system, multiple UTM balances where each UTM balance represents an amount of a particular resource belonging to the user. When a user requests a transmission of an amount of a resource to recipient(s), the validation units may use the UTM balance representing the amount of the resource belonging to the user to validate the transmission (e.g., by verifying that the user has a sufficient amount of the resource to complete the transmission). Accordingly, the cryptographic transmission system may provide a central system through which users can transmit multiple different resources using cryptography to secure the transmissions. The specific resource transmitted may also be used for distribution of transmission fees associated with a transmission.

The inventors have further recognized that conventional broadcast based transmission systems are limited to a fixed set of validation units that can be used to validate transmissions. Embodiments described herein provide a broadcast based cryptographic transmission system that allows for updating the validation units. The techniques for updating the validation units do not affect finality of transmissions. Some embodiments further include a checkpoint system that allows the cryptographic transmission system to consolidate a set of past transmissions into a checkpoint. The data records for the set of past transmissions may be deleted from memory of the validation units and represented by a checkpoint. Accordingly, the checkpoint system may reduce the amount of memory used by validation units to store a record of transmissions completed by the cryptographic transmission system.

Some embodiments of cryptographic transmission systems may be used as a payment management system. In such embodiments, payments may be implemented as transmissions of a transmission medium (e.g., tokens) from one user to another. It should be appreciated that a payment system is an illustrative application of the cryptographic transmission system described herein to illustrate aspects of the cryptographic system and associated techniques. Embodiments of the cryptographic transmission system described herein are not limited to such an application and may be used for other applications.

Referring now to the drawings that depict different embodiments consistent with the present invention, wherever possible, the same reference numbers will be used throughout the drawings and the following description to refer to the same or like parts. The payment management system 100 provides a broadcast based payment system. The payment management system 100 utilizes an account model that allows for redistributing transactions fees, recovery of locked accounts, governance certificates that determine the set of validators and govern protocol parameters like transaction fees, and the creation of checkpoints throughout the transaction process to expediate payment of transaction fees. By the use of an appropriate broadcast scheme such as a signed echo broadcast or any other appropriate broadcast, valid transactions are final as soon as the broadcast is finished, guaranteeing low latency. By the use of governance certificates, which include a checkpoint, validators (also referred to herein as “validation units”) can be replaced throughout the transaction process, and transaction fees can be paid out upon the completion of the checkpoint. In addition, because each checkpoint consolidates all previously executed transactions, all transactions prior to the checkpoint can be discarded from memory, reducing the memory requirement.

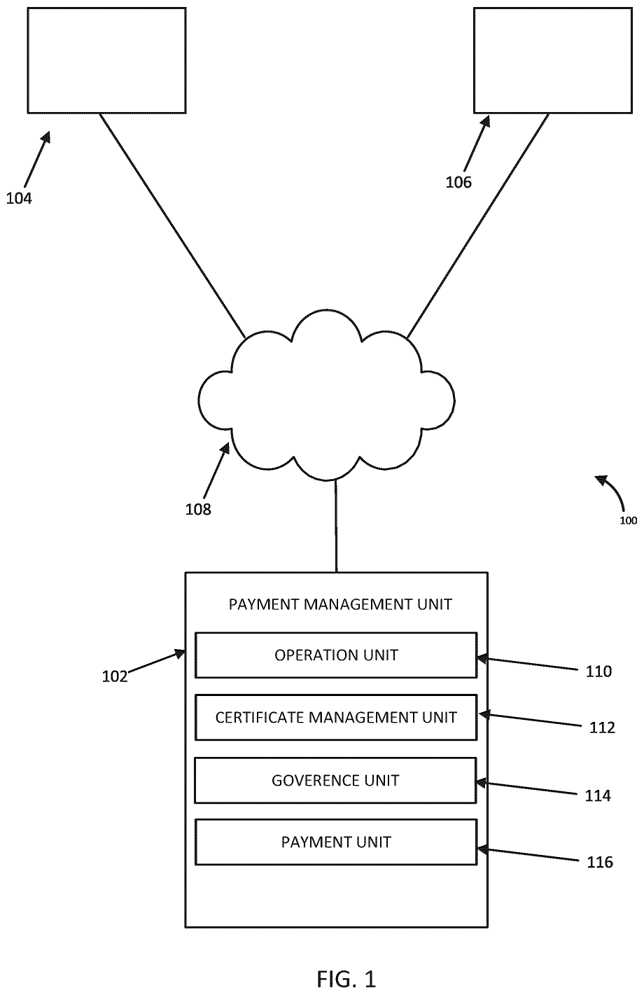

FIG. 1 depicts one embodiment of a payment management system 100 consistent with the present invention. The payment management system 100 includes a payment management unit 102, a communication device 1 104, a communication device 2 106 each communicatively connected via a network 108. The payment management unit 102 further includes an operation unit 110, a certificate management unit 112, a governance unit 114 and a payment unit 116.

The operation unit 110 and certificate management unit 112 may be embodied by one or more servers. Alternatively, each of the governance unit 114 and payment unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the row identification device may be servers, workstations, network appliances or any other suitable data storage devices. In another embodiment, the communication devices 104 and 106 may be any combination of cellular phones, telephones, personal data assistants, or any other suitable communication devices. In one embodiment, the network 108 may be any private or public communication network known to one skilled in the art such as a local area network (“LAN”), wide area network (“WAN”), peer-to-peer network, cellular network, or any suitable network, using standard communication protocols. The network 108 may include hardwired as well as wireless branches.

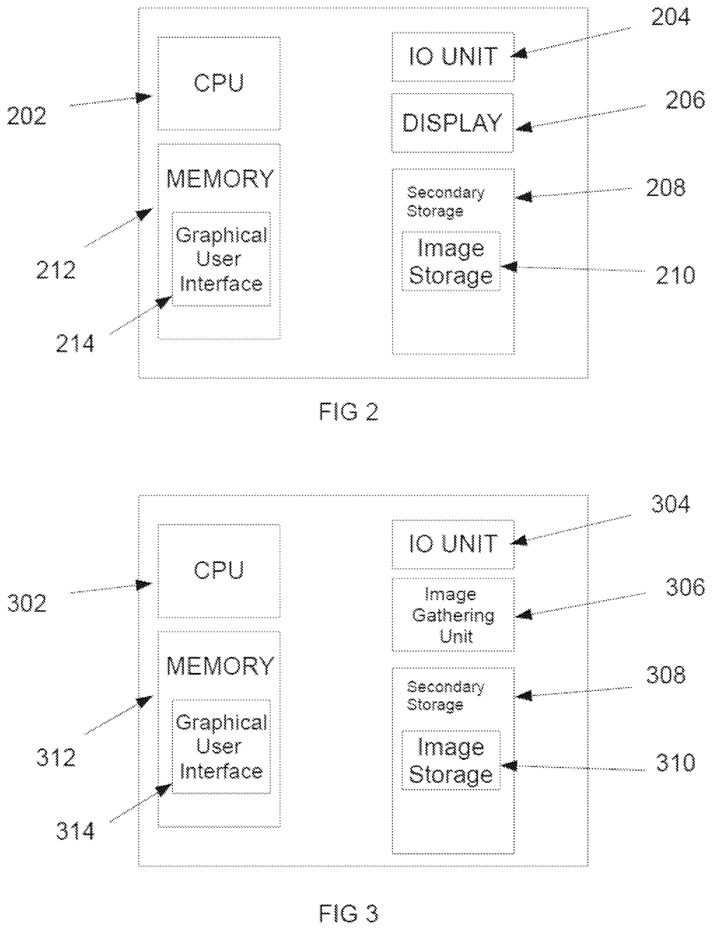

FIG. 2 depicts one embodiment of a payment management unit 102. The payment management unit 102 includes a network I/O device 204, a processor 202, a display 206 and a secondary storage 208 running image storage unit 210 and a memory 212 running a graphical user interface 214. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The governance unit 114 may be a compiled program running on a server, a process running on a microprocessor or any other suitable port control software.

FIG. 3 depicts one embodiment of a communication device 104/106 consistent with the present invention. The communication device 104/1106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network, or any suitable network, using standard communication protocols. The network 108 may include hardwired as well as wireless branches.

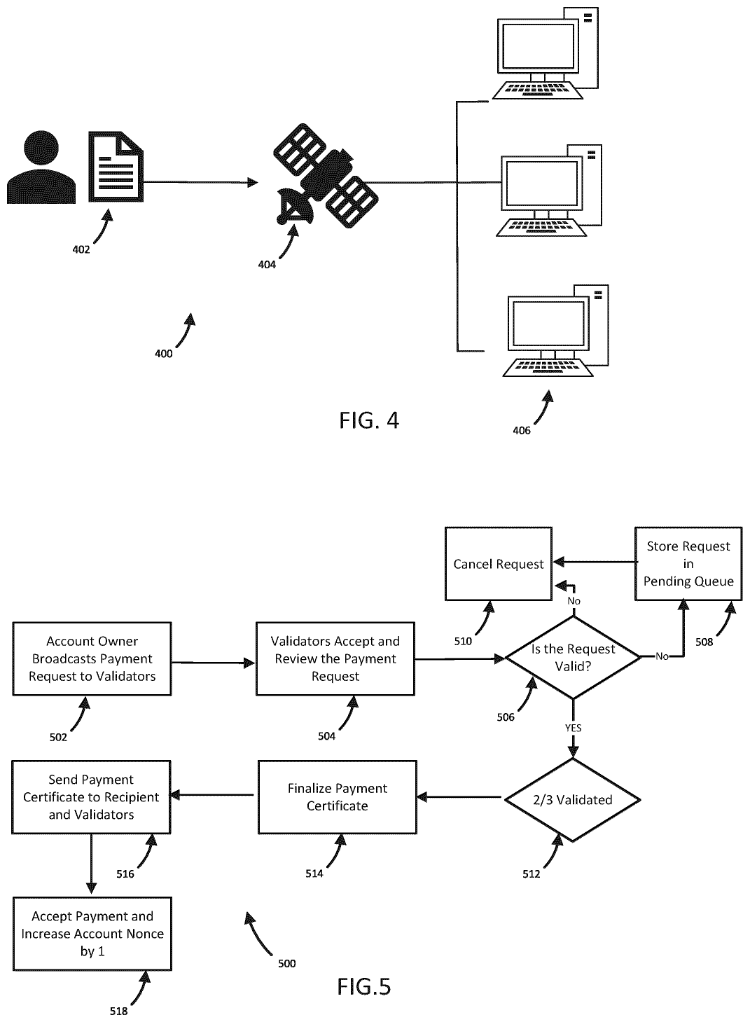

FIG. 4 depicts a schematic representation of the broadcast system 400 for the payment management system 100. An account owner 402 connects to a network 404 and sends out a payment message to a group of validators 406. The payment message is a message that includes the amount to pay, the addresses of the recipients of the funds and identifying information including a nonce associated with the account and a cryptographic signature by the account owner 402. After each validator 406 receives the payment request, the validators review the information in the request and confirm the information is correct. Once two thirds of the validators 406 verify the payment request, signatures of the validators 406 are collected and a payment certificate is sent to the account owner and the recipients of the payment. In one embodiment, the nonce is replaced with the checkpoint identification and/or the epoch identification. Consistent with this embodiment, signed transactions are only valid within one epoch and checkpoint.

In one embodiment, a third party can take the place of the account owner 402 in the process. The third party can transmit a payment message to the account owner 402 and to the validators 406. The third party retains a copy of the payment message and payment certificate after the transaction is complete. The third party, account owner and validators can request notifications of events that occur during the transaction by transmitting a subscribe message that specifies the types of events for notifications and the role of the party requesting notifications. In one embodiment, the roles include account owner, a relayer who is a third party that sends and receives messages for an account owner, a mirror that receives and stores messages related to the account, and a wallet service that can be implemented by a payment application. In another embodiment, a user account is replaced with an Unspent Transaction Output (“UTXO”). Transactions consume one or more UTXOs and send the funds represented by the UTXO to one or more new addresses, thereby creating new UTXOs. Checkpoints can agree on the current state of UTXOs, allowing for the discard of the history, and epoch transitions do not require further adaptation. Transaction fees can be charged by ensuring that the sum of UTXOs is less than the consumed UTXOs and distributed in a checkpoint by creating UTXOs without inputs. UTXOs may also be created with stealth addresses, where only recipients or parties having each party's scanning private keys, have the ability to verify the owner account of a UTXO, thereby providing transaction privacy. Other alternatives for providing privacy include, but are not limited to, signing zero knowledge computation certificates instead of transactions, masking even the existence of a balance. Such privacy-enhancing features may also be combined with the ability to force the operator to reveal balances or transactions by using threshold signatures.

FIG. 5 depicts a schematic representation of a system of processing a payment request 500. In step 502, an account owner issues a payment message to a payment network. The payment message includes the sender's identification, recipients'identification, the amount sent to each recipient, a nonce for the account, and a signature. The payment message is broadcast to all validators on the network. In step 504, validators accept and review the payment request. In reviewing the payment request, each validator verifies the format of the payment message, confirms the nonce is one larger than the last nonce sent from the account, and the account has sufficient funds to pay the amount and any transaction fees. In step 506, each validator determines the validity of the request. The validators make each judgment independently and do not communicate with the other validators. If a request is determined by a validator to have an error that can be corrected, such as a too low balance by the sender, the validator stores the request in a pending queue in step 508. If the request becomes invalid, for example by a different transaction by the same account being finalized, or if the request contains an irrecoverable error, for example a missing signature, the payment request is cancelled in step 510.

In step 512, if the request is determined to be valid by two thirds of the validators reviewing the payment request, the transaction is allowed to move forward. In step 514, a payment certificate is finalized. In finalizing the payment certificate, signatures of at least ⅔ of the validators are included in the payment certificate. The payment certificate can be in any format where at least ⅔ of the validator's signatures are aggregated. The aggregation of signatures may happen using identifiable aggregation, where the identities of the validators whose signature are contained in the aggregate signature can be recovered, and unidentifiable aggregation, where only the presence of a sufficient quantity of signatures is proven. In step 516, the payment certificate is sent to the account owner, any third parties such as relayers, the recipients and the validators. In step 518, funds are transferred to the recipients and the nonce associated with the account is increased by one.

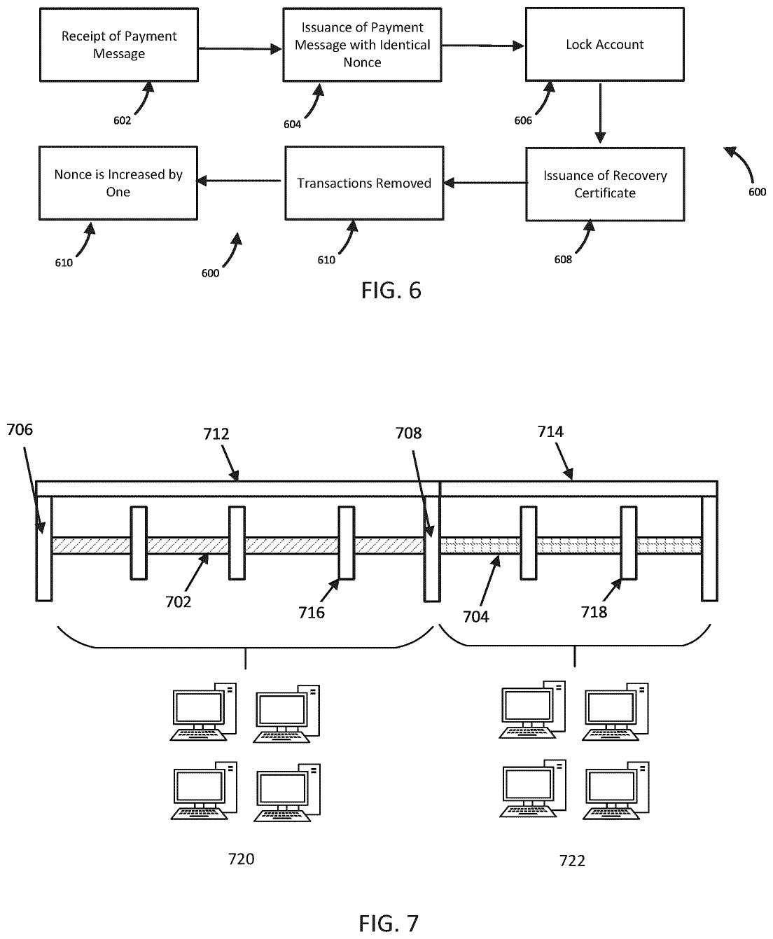

FIG. 6 depicts the schematic representation of a recovery process 600. In step 602, a payment message is transmitted with a nonce to a plurality of at least ⅓ of the validators. In step 604, a second payment message is transmitted with an identical nonce but differing in other fields such as the amount or the recipient to a different plurality of at least ⅓ of the total validators. Because the two payment messages have identical nonces and have been signed by at least ⅓ of the validators each, a two thirds majority of validators cannot be reached. In step 606, the account sending the payment messages with the identical nonces is locked. In step 608, a recovery certificate is sent to the validators. The recovery certificate contains an array of messages with the same nonce along with the signatures for these messages proving that a ⅔ majority for any transaction for this account with this nonce is impossible. A validator receives and validates a recovery message. In step 610, each validator removes the payment messages with the identical nonces. In step 612, the nonce for the account is increased by one any applicable fees are deducted from the account to unlock the account and allow for new transactions.

If an account owner wants to cancel a payment message, the account owner can send a cancellation message to the validators. Upon receipt of the cancellation message, each validator verifies the format of the cancellation message. Once two thirds of the validators have signed the cancellation message, a cancellation certificate is issued, and the payment is cancelled. Cancellation messages can be included in a recovery message to confirm an account will be unlocked. In one embodiment, an account owner may dispute a payment. Consistent with this embodiment, final payment will not be made to any account until a predetermined condition, such as an elapsed time, has occurred.

FIG. 7 is a schematic representation of a payment transaction. The validator's signatures of each transaction include epochs 702 and 704 and a checkpoints 716 and 718 which each represent a distinct time period. Each epoch 702 and 704 is initiated by an epoch transition 706 and 708 that is connected to a governance 712 and 714 for the specific epoch. A governance 712 and 714 represents the rules of the transaction including providing a list of all validators 720 and 722, updating fee parameters, updating a list of banned accounts, and software updates. The governance for each epoch 702 and 704 is transmitted to all parties in a governance certificate 712 and 714. A new epoch 702 and 704 is created for each governance certificate 712 and 714 that is issued. In one embodiment, the information related to epochs and checkpoints is included in the payment message signed by the account. In another embodiment, checkpoints 716 and 718 are only created together with an epoch 702 and 704 and only the epoch information is included in the checkpoint 716 and 718 information.

During an epoch, checkpoints 716 and 718 are created where validators confirm the transactions that have happened up to the point where the checkpoint 716 and 718 occurs in the epoch 702 and 704. In one embodiment, a checkpoint 716 and 718 is issued in the same epoch 702 and 704 without a change in the governance 712 and 714. A checkpoint allows validators to verify the current balance of each account by aggregating all transactions, allowing for the storage of only the balances for each account and to discard the transactions. A checkpoint 716 and 718 that changes protocol parameters or adds or changes validators 722 is an epoch transition 706 and 708, triggering a new epoch 704 with a new governance certificate 714. In one embodiment, the epoch transitions 706 and 708 and the checkpoints 716 and 718 are merged together into a single operation.

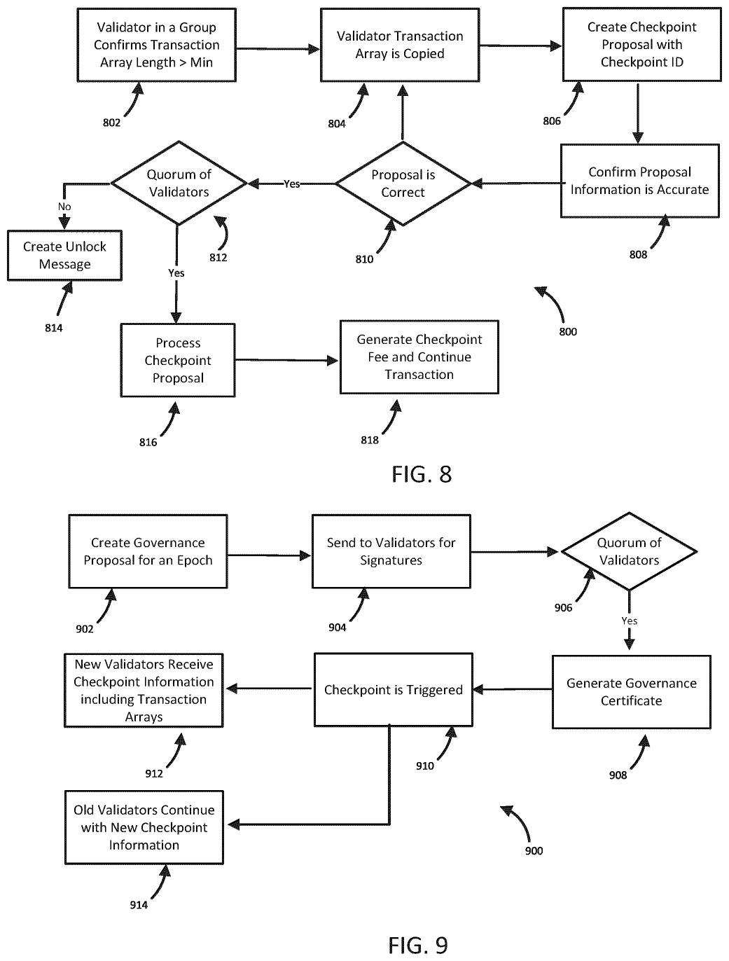

FIG. 8 depicts the schematic representation of a checkpoint creation process. In step 802, a validator, or any node, associated with a transaction confirms the transaction array length is greater than a minimum value. In one embodiment, the checkpoint 716 and 718 creation are triggered by a different event such as a request by a validator or an operator. In another embodiment, a checkpoint 716 and 718 is triggered after a predetermined amount of time has elapsed. In step 804, the validator creating the checkpoint makes a copy of the validator's transaction array. In one embodiment, the copy of the transaction array may be a simple array. In another embodiment, the copy of the transaction array may use an efficient data structure such as a Merkle tree. In step 806, the validator creates a checkpoint proposal that includes the checkpoint identifier, a signature and the transaction array. The transaction array includes a listing of all transactions the validator has identified a certificate associated with the transaction. After creating the checkpoint proposal, the validator starts signing certificates with the checkpoint identifier for the next checkpoint. The validator then sends the checkpoint proposal to the other validators. In step 808, each validator confirms the information in the checkpoint proposal is correct by confirming the conditions for creating a checkpoint are met, each transaction includes correct certificates with checkpoint identifiers up to the last identifier and the transactions each increment the account nonce by one. In step 810, each validator confirms the checkpoint proposal is correct. If a validator receiving a checkpoint proposal has witnessed more transaction certificates than what is included in a checkpoint proposal received by the validator, the validator creates a new transaction array 804 and send out a new checkpoint proposal 806 that includes an updated transaction array including the previously missing transactions. In one embodiment, the validity of the checkpoint proposal is confirmed using practical Byzantine Fault Tolerance (“BFT”). In another embodiment, the validity of the certificate proposal is confirmed using exponential information gathering, Tendermint, Narwhal/Bullshark, and generally all BFT consensus algorithms where authenticated nodes may be assumed in BFT proofs. In step 812, a quorum of ⅔ of validators confirms the checkpoint proposal is correct. In step 814, if different validators have confirmed different checkpoint proposals such that no proposal can reach ⅔ confirmations, an unlock message is created and sent out in step 814. The unlock message contains proof that a quorum is not possible along with a new checkpoint proposal.

In step 816, each validator processes the checkpoint proposal. After the proposal is processed, each validator hashes the state of all accounts and signs the checkpoint hash. In another embodiment, validators sign the hash of the transaction array. Each validator sends the checkpoint hash out over the network. Moving forward, validators sign any new certificates with the new checkpoint identifier. In step 818, the transaction fees of all transactions included in the checkpoint are calculated and paid to all validators participating in the transaction and the transaction continues. In another embodiment of the checkpoint creation process, validators use a consensus to agree on the transactions in the checkpoint.

FIG. 9 depicts a schematic representation of a process for creating a governance certificate. In step 902, a governance proposal is created. In step 904, the governance proposal is sent to all validators and each validator signs the proposal. In step 906, a quorum of at least ⅔ of the validators for the current epoch sign the proposal. In step 908, once a quorum of signatures is reached, a governance certificate is created. In one embodiment, a governance certificate is created by a central operator. In step 910, the generation of a governance certificate triggers the creation of a new checkpoint. The new checkpoint ends the current epoch and creates a new epoch controlled by the new governance certificate. The new governance certificate may remove validators, add validators, or exchange validators and set protocol parameters for the new epoch. In step 912, new validators receive checkpoint information including a full list of certificates for transactions associated with the previous epoch. In step 914, existing validators receive the new checkpoint identifier and continue signing requests. Moving forward, each validator uses the new epoch identifier.

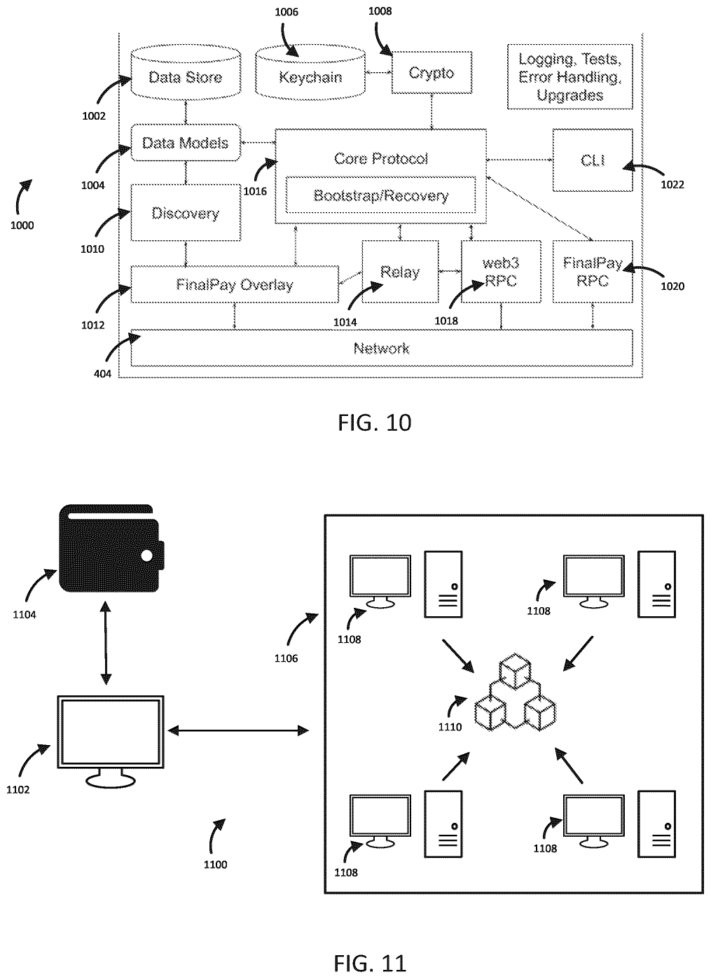

FIG. 10 is a schematic representation of a payment system 1000. The payment system 1000 includes a data store 1002 that stores all relevant data including nonces, account information including balances and other payment process data. A data model 1004 is connected to the data store 1002. The data model 1004 allows querying and modifying the protocol-related system state parameters and other data stored in the data store 1002. On a system level, the data model 1004 gets and sets checkpoint and epoch identifiers, issues checkpoints, manages governance certificates and manages the certificates issued for a transaction. The data model 1004 also manages the accounts of account holders including monitoring account balances and nonces for an account. The data model 1004 also manages the addresses of validators.

The payment system 1000 also includes a keychain 1006 and a crypto module 1008. The keychain 1006 stores private keys used to access the system and the crypto module 1008 provides an interface to sign transactions using the private keys. The crypto module 1008 also manages all signatures including aggregating signatures for certificates that are created. A discovery module 1010 is connected to the data model 1004 and discovers new nodes on the network 404. A FinalPay overlay 1012 is connected to the discovery module 1010 and manages broadcasts made over the network including payment request broadcasts and checkpoint broadcasts. A relay module 1014 is connected to the overlay 1012 which controls validator to validator communications.

The data model 1004, overlay 1012 and relay module 1014 are all connected to a core protocol module 1016. The core protocol module 1016 manages all operations 1016 of the payment system 1000 including managing transactions, initiating checkpoints, managing governance certificates, and updating account information. A Web3 RPC 1018 is connected to the core protocol module to convert Ethereum based messages to common format. A FinalPay RPC 1020 is connected to the core protocol module 1016 and manages messages sent from external sources to the core protocol module 1016. A CLI module 1020. A CLI module 1022 that handles addressing of nodes is connected to the core protocol module 1016.

FIG. 11 depicts a schematic representation of a ledger system 1100. The ledger system 1100 includes a safe investment financial account unit 1104 communicatively connected to a trusted operator unit 1102. The safe investment financial account unit 1102 may be any monetary account including, but not limited to, a bank account, investment account or cryptocurrency wallet. The trusted operator unit 1102 is communicatively coupled to a distributed ledger technology (“DLT”) system 1106. The DLT system 1106 consists of validator units 1108 that each communicate under the rules of a DLT protocol 1100. In one embodiment, the DLT protocol 1110 is a level one transaction protocol. The DLT protocol 1110 ensures eventual consistency of the ledger records under Byzantine Fault Tolerance using a consensus mechanism, such as deterministic security guarantees using Ethereum or Solana blockchain, or a broadcast mechanism. The DLT protocol 1110 may also incorporate sybil protection mechanism such as proof-of-state or proof-of-authority permission.

The validator units 1108 replicates a ledger of balances for all accounts. The ledger system has a data structure that stores at least one token balance per account and verifies that adequate funds exist in the safe investment financial account unit 1104 to financially back each newly minted token. The ledger may also store nonces or transaction counters, text including code and the state of a smart contract. The data structure may be a list, a hashmap or another appropriate data structure. Transactions under the ledger system are in the form of messages including a sender, a receiver and an amount. Each message is signed by the sender using public key cryptography or UTXO.

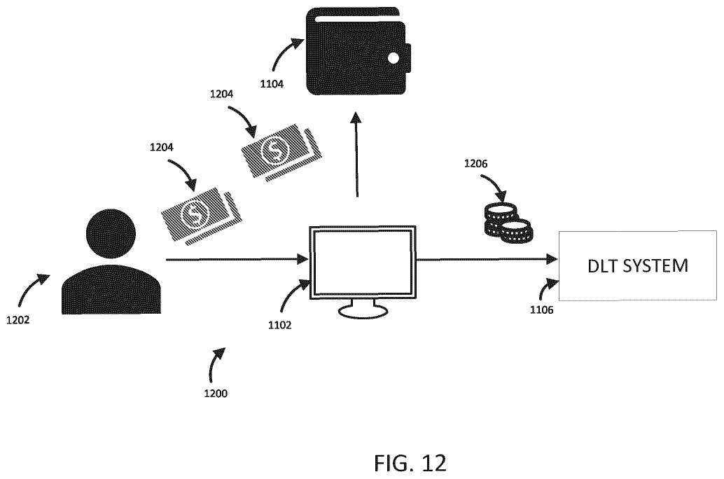

FIG. 12 depicts a schematic representation of a minting process 1200 for a token. The DLT protocol 1100 includes a plurality of tokens with each token corresponding to a unit of fiat currency held in the safe investment financial account unit 1104. A user 1202 sends money 1204, or proof of funds in the safe investment financial account unit 1104, to the operator unit 1102 using traditional means of payment such as a bank transfer. The operator unit 1102 transmits a mint transaction 1206 to the DLT system 1106. The mint transaction 1206 represents a transaction that has one of potentially multiple mint safe investment financial account unit 1104 as the sender. Safe investment financial account unit 1104 is defined in the DLT protocol 1110 and can be changed using the DLT protocol 1110. Changing safe investment financial account unit 1104 requires the signature of the operator unit 1102. Safe investment financial account unit 1104 includes accounts that are defined to have a balance of zero or any arbitrary balance that is not counted towards the total fiat-backed token supply, but may always send arbitrary amounts to other accounts. The operator unit 1202 is trusted to only issue a mint transaction when the safe investment wallet unit 1204 has a corresponding inflow of a fiat currency.

A burn transaction is a transaction with a safe investment financial account unit 1104 as a recipient. Users 1202 can withdraw tokens 1206 from the DLT system 1106 to convert the tokens 1206 back into fiat cash 1204 by providing payment details such as a bank account number to the operator and issue a burn transaction. Once the burn transaction has been finalized by the BFT protocol, the operator unit 1102 issues a fiat payment to the recipient, using the funds invested in the safe asset and the previously minted tokens are removed from the ledger. In one embodiment, where funds were not transferred to the operator unit 1102, the burn process clears the ledger of tokens minted with untransformed funds.

In one embodiment, the DLT protocol 1110 may include a plurality of subsystem including, but not limited to, a payment sub-system, a checkpoint sub-system and a governance sub-system. The payment sub-system control payments, cancellations and recoveries and is controlled by a broadcast mode. The checkpoints sub-system controls memory management including deleting prior transactions and payment of transaction fees. The checkpoints sub-system is controlled by a consensus mode. The governance sub-system controls the updates to protocol parameters and committed management. The governance sub-system is controlled by a consensus mode. The minted tokens may be used to pay transaction fees or any other required settlement.

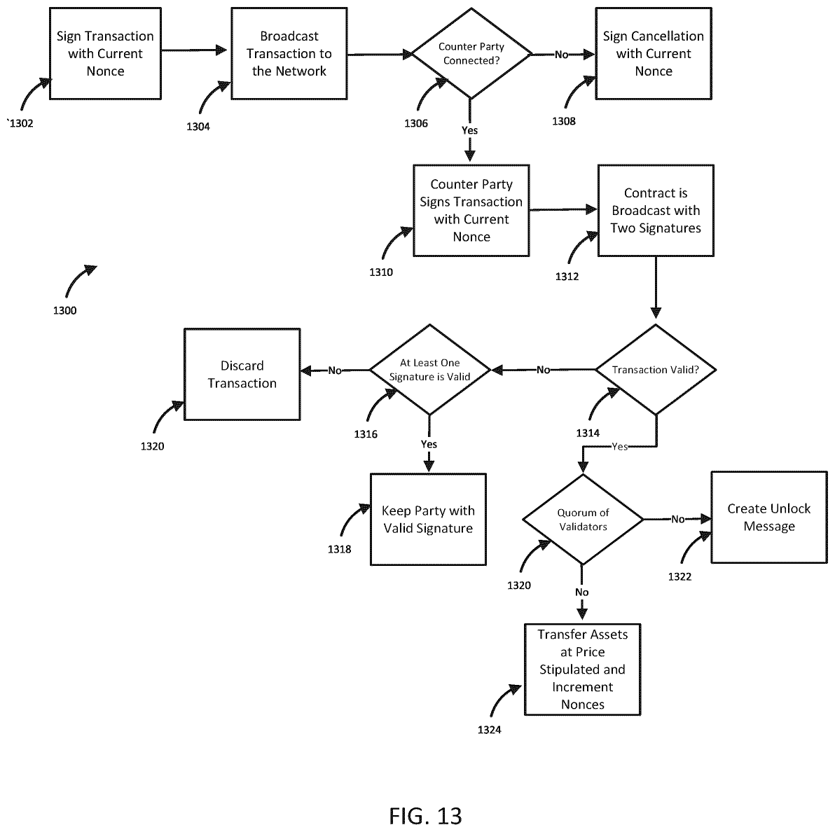

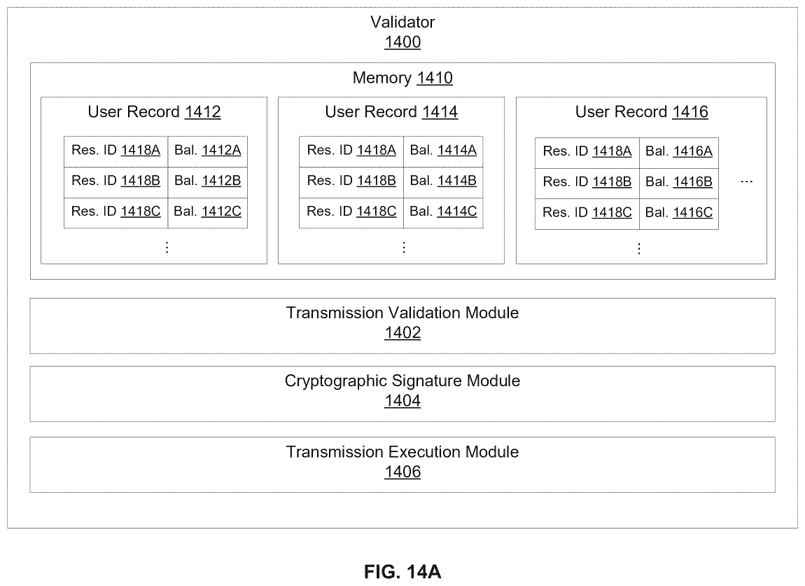

FIG. 13 depicts a schematic representation of a settlement process 1300. In step 1302, a transaction is signed by a first party to a transaction. In step 1304, the signed transaction is broadcast on a network. In step 1306, the first party waits until the second party is connected to the network. In step 1308, if the second party does not connect, the first party signs a cancellation for the transaction. In step 1310, if the second party connects to the network, the second party signs the transaction using the current nonce. In step 1312, the contract signed by both parties is broadcast on the network. In step 1314, a plurality of validators determines if the transaction is valid. In step 1316, the validators check if at least one signature is valid. In step 1320, if no signatures are valid, the transaction is discarded. In step 1318, if one signature is valid, the contract is kept for the valid signing party. In step 1320, if the transaction is valid, the validator confirms if a quorum of validators has validated the transaction. In step 1322, if a quorum has not validated the transaction, an unlock code is generated and the transaction is locked. In step 1324, if the transaction is validated by a quorum, assets are transferred between the parties at a predetermined price and each party's nonce is incremented.

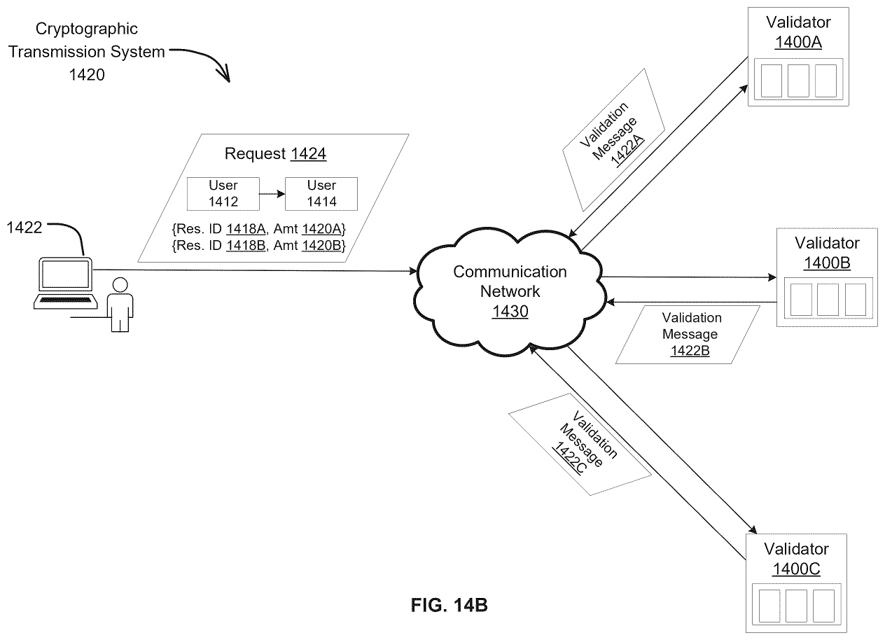

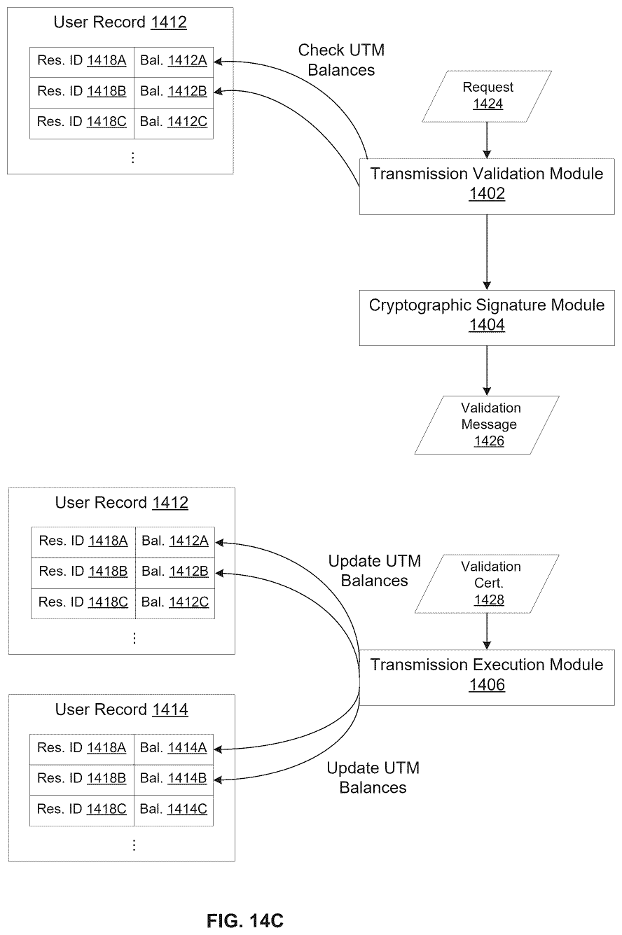

FIG. 14A depicts an example validator (also referred to herein as a “validation unit”) 1400 of a cryptographic transmission system for transmission of multiple different resources, according to some embodiments of the technology described herein. As shown in FIG. 14A, the validator 1400 includes a transmission validation module 1402, a cryptographic signature module 1404, and memory 1410 storing UTM balances for users of the cryptographic transmission system.

In the example of FIG. 14A, the memory 1410 includes a set of user records 1412, 1414, 1416. The memory 1410 may store records for users in addition to the user records 1412, 1414, 1416 depicted in FIG. 14A. For user record 1412, the memory 1410 stores a set of identifications for different resources (“resource identifiers”) 1418A, 1418B, 1418C. The memory 1410 stores UTM balances 1412A, 1412B, 1412C, where each UTM balance represents an amount of one of the resources belonging to a respective user associated with user record 1412. The memory 1412 stores each of the UTM balances 1412A, 1412B, 1412C in association with a corresponding identifier indicating the resource represented by the UTM balance. UTM balance 1412A is stored in association with resource identifier 1418A, UTM balance 1412B is stored in association with resource identifier 1418B, and UTM balance 1412C is stored in association with resource identifier 1418C.

For user record 1414, the memory 1410 stores the set of resource identifiers 1418A, 1418B, 1418C and respective UTM balances 1414A, 1414B, 1414C. Each of the UTM balances 1414A, 1414B, 1414C represents an amount of one of the resources indicated by the resource identifiers 1418A, 1418B, 1418C belonging to the respective user associated with the user record 1414. Likewise, for user record 1416, the memory 1410 stores the set of resource identifiers 1418A, 1418B, 1418C and respective UTM balances 1416A, 1416B, 1416C. Each of the UTM balances 1416A, 1416B, 1416C represents an amount of one of the resources indicated by the resource identifiers 1418A, 1418B, 1418C belonging to the respective user associated with the user record 1416.

The UTM balances stored in the memory 1410 may be balances of any suitable UTM. In some embodiments, the UTM balances may each be a number of coins. The number of coins may represent an amount of a particular resource belonging to a user. Coins may be issued to a particular UTM balance of a user based on an indication of an among of a corresponding resource represented by the UTM balance. For example, UTM balance 1412A may be a number of coins representing an amount of a first currency belonging to a user associated with user record 1412, UTM balance 1412B may be a number of coins representing an amount of a second currency belonging to the user, and UTM balance 1412C may be a number of coins representing an amount of a third currency belonging to the user. UTM balance 1414A may be a number of coins representing an amount of the first currency belonging to a user associated with user record 1414, UTM balance 1414B may be a number of coins representing an amount of the second currency belonging to the user, and UTM balance 1414C may be a number of coins representing an amount of the third currency belonging to the user. UTM balance 1416A may be a number of coins representing an amount of the first currency belonging to a user associated with user record 1416, UTM balance 1416B may be a number of coins representing an amount of the second currency belonging to the user, and UTM balance 1416C may be a number of coins representing an amount of the third currency belonging to the user. As another example, a UTM balance may be a number of coins indicating an amount of a commodity belonging to a user. As another example, a UTM balance may be a number of coins indicating an amount of a financial instrument belonging to a user.

The resources identified by the resource identifiers 1414A, 1414B, 1414C may indicate any suitable resource. In some embodiments, the resource may be any transferrable asset belonging to the user. For example, a resource identifier may indicate a particular currency (e.g., United States Dollar, Euro, Japanese Yen, Pound Sterling, Canadian Dollar, Australian Dollar, Indian Rupee, or another currency). A UTM balance associated with the resource identifier stored in a user record may represent an amount of the currency belonging to a user associated with the user record. As another example, a resource identifier may indicate a commodity (e.g., gold, silver, copper, aluminum, crude oil, natural gas, coal, electricity, wheat, barley, coffee, rice, beef, beans, cotton, sugar, cocoa, or another commodity). A corresponding UTM balance in a user record may represent an amount of the currency belonging to a user associated with the user record. As another example, a resource identifier may indicate a financial instrument (e.g., stock, bond, cryptocurrency, mutual fund, derivative, or another financial instrument). A corresponding UTM balance in a user record may represent an amount of the financial instrument belonging to a user associated with the user record. In some embodiments, different UTM balances may correspond to different types of assets. For example, one UTM balance may represent an amount of a currency belonging to a user while another UTM balance may represent an amount of a commodity belonging to the user.

In some embodiments, the memory 1410 may store the user records 1412, 1414, 1416 as data structures. The memory 1410 may use any suitable data structure to store a user record. For example, the memory 1410 may store the user records 1412, 1414, 1416 as matrices, arrays, linked lists, trees, or another suitable data structure. In some embodiments, the memory 1410 may organize the user records 1412, 1414, 1416 based on an index. The validator 1400 may be configured to search for a user record (e.g., to validate a transmission by a particular user associated with the user record) using the index.

The memory 1410 may comprise storage hardware storing the user records 1412, 1414, 1416. The storage hardware may include one or more hard drives (e.g., hard disk drives (HDD) and/or solid-state drives (SSD)). In some embodiments, the memory 1410 may be part of network attached storage (NAS). In some embodiments, the memory 1410 may be part of a storage area network (SAN). In some embodiments, the memory 1410 may comprise cloud storage in which the user records 1412, 1414, 1416 are stored in one or more servers (e.g., in one or more data centers). The memory 1410 may be accessed by the validator 1400 through a communication network (e.g., the Internet). In some embodiments, the memory 1410 may be a local hard drive of the validator 1400.

As shown in FIG. 14A, the validator 1400 includes a transmission validation module 1402, a cryptographic signature module 1404, and a transmission execution module 1406.

In some embodiments, the transmission validation module 1402 may be configured to validate transmissions of the UTM requested in a cryptographic transmission system (e.g., indicated by messages transmitted to the validator 1400). The transmission validation module 1402 may be configured to validate a given transmission using UTM balances stored in a user record of a user that requested the transmission. The transmission validation module 1402 may be configured to validate a requested transmission using the UTM balances by: (1) identifying UTM balance(s) of the user representing amount(s) of respective resource(s) that are to be transmitted in the transmission, and (2) determine whether the UTM balance(s) are sufficient to complete the transmission. For example, for a transmission of United States Dollars from a user to one or more recipients, the transmission validation module 1402 may determine whether a user's UTM balance representing an amount of United States Dollars belonging to the user is sufficient to transmit a requested amount. As another example, for a transmission of an amount of a commodity to one or more recipients, the transmission validation module 1402 may determine whether a user's UTM balance representing an amount of the commodity belonging to the user is sufficient to transmit a requested amount of the transmission.

In some embodiments, the cryptographic signature module 1404 may be configured to cryptographically sign a message indicating that a requested transmission is valid after the transmission validation module 1402 determines that the requested transmission is valid. The cryptographic signature module 1404 may be configured to generate a signature unique to the validator 1400. For example, the cryptographic signature module 1404 may sign a message using a private key of the validator 1400 (e.g., that can be verified by a corresponding public key). As another example, the cryptographic signature module 1404 may sign a message using a symmetric key (e.g., that can be verified using the same key by another device). In some embodiments, the cryptographic signature module 1404 may be configured to generate a signature by signing a hash using a key of the validator 1400. In some embodiments, the cryptographic signature module 1404 may be configured to attach a generated signature in a set of data (e.g., a message). In some embodiments, the cryptographic signature module 1404 may be configured to generate a signature using a signature algorithm. For example, the cryptographic signature module 1404 may generate a signature using a digital signature algorithm (DSA) or the Ron Rivest, Adi Shamir, and Leonard Adleman (RSA) algorithm.

In some embodiments, the transmission execution module 1406 may be configured to execute transmissions. The transmission execution module 1406 may be configured to execute a transmission by updating UTM balances involved in a transmission. For each of one or more resources being transmitted from a sender to one or more recipients in a transmission, the transmission execution module 1406 may update UTM balances of the sender and the recipient(s) to reflect the transmission of resource(s). For example, for a transmission of an amount of United States Dollars from a sender to a recipient, the transmission execution module 1406 may update a UTM balance of the sender representing an amount of dollars belonging to the sender (e.g., by reducing the UTM balance according to the requested amount of transmission) and a UTM balance of the recipient representing an amount of dollars belonging to the recipient (e.g., by increasing the UTM balance according to the requested amount of transmission).

In some embodiments, the transmission execution module 1406 may be configured to update multiple UTM balances of both a sender and recipient(s) as part of executing a single transmission. The transmission may comprise a transmission of multiple different resources from a sender to recipient(s). Accordingly, the transmission execution module 1406 may be configured to: (1) update UTM balances representing amounts of the resources belonging to the sender, and (2) update UTM balances representing amounts of the resources belonging to the recipient(s).

In some embodiments, the transmission execution module 1406 may be configured to execute a given transmission after the validator 1400 receives an indication that the transmission has been approved. For example, the transmission execution module 1406 may execute the transmission after receiving a validation certificate indicating that a threshold number of validators has validated the transmission. As another example, the transmission execution module 1406 may execute the transmission after receiving an indication that a network of validators has reached a consensus (e.g., using a consensus algorithm) that the transmission is valid.

FIG. 14B depicts an example validation of a transmission indicated by a request 1424 being performed by validators in a cryptographic transmission system 1420, according to some embodiments of the technology described herein. As shown in FIG. 14B, a device 1422 (e.g., a device associated with a sender, a relay device, or another device with permission to request the transmission) transmits the request 1424 through a communication network 1430 to a network of validators that includes validators 1400A, 1400B, 1400C. Each of the validators 1400A, 1400B, 1400C may be as described herein with reference to FIG. 14A.

As shown in FIG. 14B, the request 1424 includes a specification of a sender as a user associated with user record 1412 and a recipient as a user associated with user record 1414. The request 1424 further specifies resource identifiers of resources to be transferred as part of the transmission and amounts of each of the resources. Specifically, the request 1424 specifies an amount 1420A for resource identifier 1418A and an amount 1420B for a resource identifier 1418B. In some embodiments, the request 1424 may include information in addition to the information illustrated in FIG. 14B. For example, the request 1424 may include a nonce of the sender. As another example, the request 1424 may include a nonce of the recipient (e.g., for an atomic settlement). In some embodiments, the request 1424 may be transmitted to the network of validators as one or more messages. For example, the request 1424 may comprise a single message transmitted by a sender. As another example, the request 1424 may comprise multiple messages by multiple parties involved in the transmission (e.g., sender and recipient(s)).

In some embodiments, the cryptographic transmission system 1420 may be configured to use atomic settlement (e.g., as described herein with reference to FIG. 13). Accordingly, both the sender and recipient(s) may be required to sign respective messages with their respective nonces for the transmission to be successfully validated by the network of validators. Thus, the request 1424 may comprise of multiple messages transmitted by all parties involved in a transmission. Validators may check that messages contain the current nonces, and that both parties have a sufficient amount of the resource they want to transmit. The parties may be blocked from performing other transmissions until validation of the transmission is finalized or the transmissions is cancelled. In some embodiments, the transmission may only be valid if certain information included in messages from the parties match. If the transmission is invalid, the parties can cancel the transmission. If there is a conflict, an unlock message may be used to unlock the parties such that they are able to perform other transmissions.

For example, the cryptographic transmission system 1420 may use pure over-the-counter (OTC) atomic settlement in which the parties each sign messages requesting a transmission with the following information: (1) a current nonce of the party, (2) an account to trade with, (3) resource identifier(s) of resource(s) to be transmitted, (4) resource(s) identifier(s) of resource(s) to be received, (5) an amount of the resource(s) to be transmitted, and (6) an amount of the resource(s) to be received. Validators may compare the information included in messages received from the sender and recipient(s) to validate the transmission.

As another example, the cryptographic transmission system 1420 may use an order book style atomic settlement. The parties may sign messages requesting a transmission with the following information: (1) a current nonce of the party, (2) identifier(s) of resource(s) to be transmitted, (3) identifier(s) of resource(s) to be received, (4) a maximum amount of the resource(s) to be transmitted, and (5) a minimum amount of the resource(s) to be received. Validators may compare the information included in messages received from the sender and recipient(s) to validate the transmission.

As another example, the cryptographic transmission system 1420 may use a hybrid atomic settlement approach. One party may send a message including: (1) its current nonce, (2) identifier(s) of resource(s) to transmit, (3) identifier(s) of resource(s) to be received, (4) a maximum amount of the resource(s) to be transmitted, and (5) an exchange rate to be received. Another party may send a message including: (1) its current nonce, (2) a reference to an offer indicating resource(s) to be transmitted and received along with an exchange rate, and (3) an amount of the resource(s) to be transmitted at the exchange rate. In this example, the first message may be signed at one point in time (e.g., by a market maker) and the second message would be generated and finalized instantly based on the first message.

In some embodiments, a transmission may involve multiple resources. An atomicity guarantee may extend to all exchanges in the transmission. Both parties may sign messages containing: (1) their current nonces, (2) accounts to be exchanged with, and (3) a list of exchanges. Each item in the list indicates: an identifier of a resource to be transmitted, an identifier of a resource to be received, an amount of the resource to be transmitted, and an amount of the resource to be received. Validators may determine whether both parties have sufficient amounts of the resources (e.g., based on UTM balances) to validate the transmission. Validators may execute the transmission when they receive an indication of approval (e.g., a validation certificate or an indication that consensus is reached). In some embodiments, more than two parties may agree to a set of transmissions that may involve multiple resources. An atomicity guarantee may extend to all swaps in the transmission. Each of the parties signs a respective message containing: (1) its current nonce, and (2) a list of transmissions where each entry in the list comprises a pair of exchanges. Each item in the list contains the following fields: (1) account transmitting the resource, (2) an identifier of the resource, and (3) an amount of the resource to be transmitted. A multi-party settlement transmission may only be valid if a copy of it is signed by all senders with their current nonces. Validators check that all senders have sufficient amounts of the resources to be transmitted.

In some embodiments, the cryptographic transmission system 1420 may split percentages when combining multiple orders. The percentages may be determined using a number of rules (e.g., proportional to the volume limits in the transmissions or the same for everyone). In many split models (e.g., equal for everyone) there may be rounding issues (e.g., if $100 has be split equally among three parties). In this case the system may have a rule to match one unit more of the smallest denomination supported in the network from one party. Some embodiments may use fair pseudorandom matching to pick the party. For example, matching may be performed by taking the hash of the accounts in the transaction, concatenating the hashes in ascending numerical order, and then picking the account number closest in numerical value to the hash. Ties may be broken using the last bit of the hash (e.g., 0—pick the one, 1—pick the other).

In some embodiments, the cryptographic transmission system 1420 may be configured to keep partially completed transmissions alive. In the orderbook and hybrid atomic settlement embodiments, it makes sense to allow matching only part of the amount that a party would be willing to transmit. In the standard version, that order would then still be considered resolved, so if a party whose transmission was partially completed wants to make more transmissions in the same resource pair at the same price, they would have to sign a new message. The system may be configured to allow keeping a partially completed transmission alive if the party on the other side of the transmission includes a new nonce specific to the transmission of the other party. The message of the second party in the hybrid model would then contain the fields: (1) the current nonce, (2) reference to an offer of a first type to transmit (which specifies a resource to transmit and receive and an exchange rate), (3) a nonce of the referenced offer, and (4) an amount of the resource to transmit at the exchange rate. Validators would check that the nonce of the referenced offer is indeed the latest nonce for that offer, in addition to the other fields. The rest of the transmission processing happens in the same way, and after the transmission is final, the referenced offer remains alive, with the maximum amount reduced by the amount in the transmission.

As shown in FIG. 14B, the validators 1400A, 1400B, 1400C validate the requested transmission. The validators 1400A, 1400B, 1400C may be configured to validate the requested transmission using UTM balances stored in user records (e.g., as described herein with reference to FIG. 14C). When a validator determines that the requested transmission is valid, the validator transmits a validation message to the device 1422. The validation message may include a cryptographic signature of the validator. In the example of FIG. 14B, the validator 1400A transmits validation message 1422A including its signature to the device 1422 through the communication network 1430, the validator 1400B transmits validation message 1422B including its signature to the device 1422 through the communication network 1430, and the validator 1400C transmits validation message 1422C including its signature through the communication network 1430. In some embodiments, the validators 1400A, 1400B, 1400C may be configured to execute the transmission in response to receiving an indication of approval. For example, the validators 1400A, 1400B, 1400C may execute the transmission in response to receiving a validation certificate (e.g., indicating that a threshold number of validators have determined the transmission to be valid or that consensus has been reached by the validators).

FIG. 14C depicts the operation of a validator in validating the requested transmission of FIG. 14B, according to some embodiments of the technology described herein. The transmission indicated by the request 1424 specified an amount of resource identifier 1418A and an amount of resource identifier 1418B to be transmitted from the user associated with user record 1412 to the user associated with user record 1414.As shown in FIG. 14C, the transmission validation module 1402 first checks the UTM balances 1412A, 1412B associated with respective resource identifiers 1418A, 1418B in the user record 1412. The transmission validation module 1402 may be configured to determine whether the UTM balances 1412A, 1412B are sufficiently high to complete the requested transmission. For example, the transmission validation module 1402 may determine if the UTM balances 1412A, 1412B represent amounts of respective resources that is greater than amounts of the resources requested for transmission. As another example, the transmission validation module 1402 may determine if the UTM balances 1412A, 1412B represent amounts of respective resources that is greater than the amounts of the resources requested for transmission by a threshold amount (e.g., to ensure that there is a sufficient balance for distribution of transmission fees to validators and/or other entities).

In some embodiments, the transmission validation module 1402 may be configured to perform other checks in addition to determining whether the balances 1412A, 1412B are sufficient. For example, the transmission validation module 1402 may check nonces provided by one or more parties involved in the transmission. As another example, the transmission validation module 1402 may determine whether the information in messages from different parties aligns (e.g., as described herein with reference to FIG. 14B for atomic settlements).

Once the transmission validation module 1402 determines that the UTM balances 1412A, 1412B are sufficient to complete the transmission, the cryptographic signature module 1404 may sign a validation message 1426 indicating that the requested transmission is valid. In some embodiments, the cryptographic signature module 1404 may be configured to sign the validation message 1426 with a cryptographic signature of the validator 1400. The cryptographic signature module 1404 may be configured to transmit the validation message 1426 to the device 1422 indicating that the validator has determined the requested transmission to be valid.

As shown in FIG. 14C, the transmission execution module 1406 executes the transmission in response to receiving a validation certificate 1428. In some embodiments, the validation certificate 1428 may indicate that a threshold number of validators have determined the requested transmission to be valid. In some embodiments, the validation certificate 1428 may indicate that the validators of the validation network have reached a consensus that the requested transmission is valid (e.g., using a consensus algorithm). As shown in FIG. 14C, the transmission execution module 1406 executes the transmission by: (1) reducing UTM balances 1412A, 1412B corresponding to resource identifiers 1418A, 1418B of the user record 1412 by the amount specified in the request 1424 (i.e., because the user associated with the user record 1412 is the sender in the requested transmission), and (2) increasing the UTM balances 1414A, 1414B corresponding to resource identifiers 1418A, 1418B by the amount specified in the request 1424 (i.e., because the user associated with the user record 1414 is the recipient in the requested transmission). In some embodiments, the transmission execution module 1406 may be configured to unlock the users involved in the transmission such that they may perform transmissions in the cryptographic transmission system 1420.

In some embodiments, the validators 1400A, 1400B, 1400C that validated the requested transmission may receive transmission fees. The validators 1400A, 1400B, 1400C may be configured to receive, from one or more of the parties involved in the transmission, amounts of the UTM representing the resources involved in the transmission. Users associated with the validators 1400A, 1400B, 1400C may have associated user records of UTM balances corresponding to resource identifiers (e.g., a described in the memory 1410 of the validator 1400). The user records may be updated based on the UTM transmissions. For example, UTM balances of the users associated with resource identifier 1418A may be updated to include a percentage of the UTM amount that was transmitted for the corresponding resource, and UTM balances of the users associated with resource identifier 1418B may be updated to include a percentage of the UTM amount that was transmitted for the corresponding resource. Accordingly, validators may be distributed transmission fees in the UTM that was involved in the transmission.

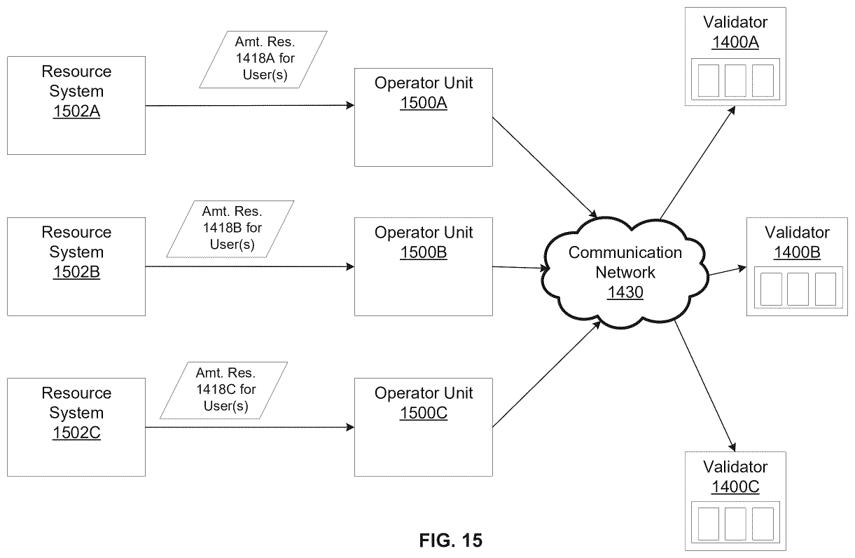

FIG. 15 depicts issuance of amounts of a uniform transmission medium to users of a cryptographic transmission system, according to some embodiments of the technology described herein. As shown in FIG. 15, the cryptographic transmission system includes operator units 1500A, 1500B, 1500C which receive indicates of amounts of respective resources belonging to users and transmit messages to a network of validators to issue amounts of UTM to users (e.g., by updating user records).

In some embodiments, each of the operator units 1500A, 1500B, 1500C may be associated with a particular one of the plurality of resources. For example, operator unit 1500A may be associated with a resource indicated by resource identifier 1418A, operator unit 1500B may be associated with a resource indicated by resource identifier 1418B, and operator 1500C may be associated with a resource indicated by resource identifier 1418C. As shown in FIG. 15, the operator units 1500A, 1500B, 1500C may be configured to communicate with respective resource systems 1502A, 1502B, 1502C. For example, the operator units 1500A, 1500B, 1500C may be configured to communicate with respective resource systems 1502A, 1502B, 1502C through respective application program interfaces (APIs). In some embodiments, an operator unit may be configured to receive, from a respective resource system, amounts of a particular resource belonging to a particular user. For example, an operator unit may receive an indication of an amount of currency belonging to a user from a resource system (e.g., a bank). As another example, an operator unit may receive an indication of an amount of a commodity belonging to a user from a resource system (e.g., a commodity trading platform).

In some embodiments, an operator unit may be configured to communicate with multiple resource systems. Although in the embodiment of the FIG. 15 the system includes multiple operator units, in some embodiments, the system may include a single operator unit that communicates with the resource systems 1502A, 1502B, 1502C.

In some embodiments, an operator unit may be configured to receive an indication of an amount of a respective resource belonging to a user. The operator unit may be configured to determine an amount of the UTM representing the amount of the resource belonging to the user. The operator unit may be configured to transmit a message indicating to issue the determined amount of the UTM to the user. The message may cause the validators to update a UTM balance of the user associated with the resource (e.g., by increasing UTM balance by the UTM amount issued). The validators 1400A, 1400B, 1400C may be configured to receive the message indicating the amount of the UTM to issue to the user for the resource and, in response, update the UTM balance associated with the resource (e.g., by a corresponding resource identifier). For example, the validators may update the UTM balance by increasing the UTM balance by the amount of UTM indicated by the issuance message.

In some embodiments, an operator unit may be configured to determine an amount of UTM to issue to a user by converting an indicated amount of a resource belonging to the user to the amount of UTM. For example, the operator unit may be configured to use conversion rates of amounts of resources to amounts of UTM. The operator unit may use the conversion rates to determine amounts of UTM to issue to different UTM balances in user records. In some embodiments, the conversion rates may be variable over time. In some embodiments, the conversion rates may be static. In some embodiments, an operator unit may be configured to receive, from a device, an indication of an amount of UTM to be removed from a UTM balance of a user of the cryptographic transmission system. The operator unit may be configured to transmit a message to the network of validation units indicating a command to remove the amount of UTM from the UTM balance of the user of the cryptographic transmission system.

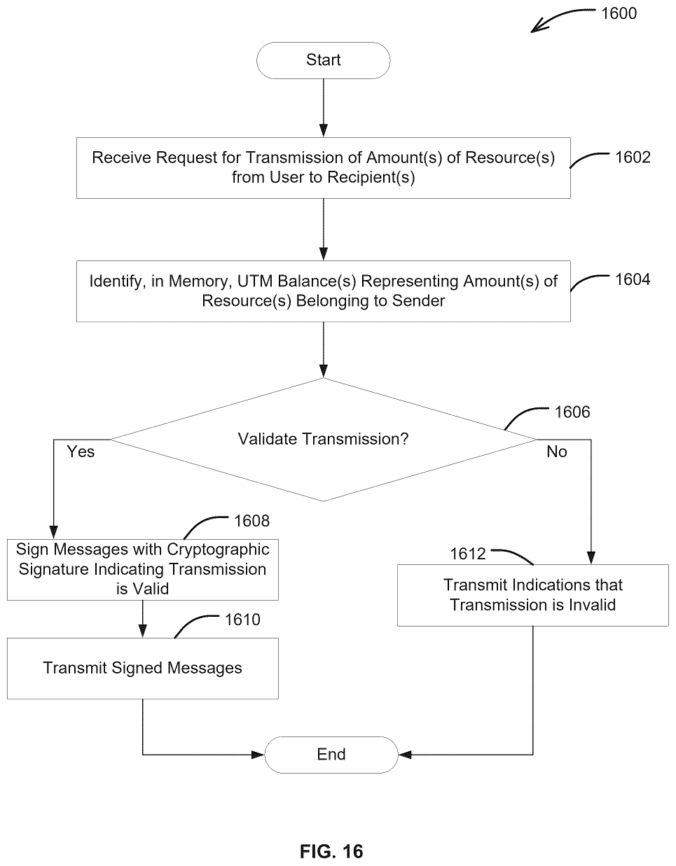

FIG. 16 depicts an example process 1600 for transmitting one or more resources using a cryptographic transmission system, according to some embodiments of the technology described herein. For example, process 1600 may be performed using the cryptographic transmission system 1420 described herein with reference to FIGS. 14A-14C (e.g., with validators configured as described herein with reference to FIG. 14A).

Process 1600 begins at block 1602, where validation units of the cryptographic transmission system (e.g., of a network of validation units) receive a message indicating a request for a transmission of amount(s) of one or more resources from a user (also referred to as the “sender”) to a set of one or more (also referred to as the “set of recipient(s)”). In some embodiments, the validation units may be configured to receive a request comprising a message from the sender. The message may indicate identifier(s) of the resource(s) and the amount(s) of the resource(s) along with a current nonce of the sender. In some embodiments, the system may use atomic settlement in which the validation units are configured to receive messages from the sender and the set of recipient(s) (e.g., as described herein with reference to FIG. 14B). For example, each of the messages may indicate a current nonce of the user, identifier(s) of resource(s) to be transmitted, and amount(s) of resource(s) to be transmitted. Other examples of information that may be included in the messages are described herein with reference to FIG. 14B.

Next, process 1600 proceeds to block 1604, where the validation units identify, in their respective memories, UTM balance(s) representing amount(s) of the resource(s) to be transmitted that belong to the sender. A validation unit may be configured to read a user record from its memory storing UTM balances of the sender, where each UTM balance represents an amount of a particular resource that belongs to the sender. For example, the validation unit may identify a data structure (e.g., a table, matrix, or other data structure) in its memory storing the user record. The validation unit may identify, in the data structure, UTM balance(s) representing amount(s) of the resource(s) to be transmitted that belong to the sender. For example, the validation unit may identify, in the data structure, number(s) of tokens that each represent an amount of one of the resource(s) that belong to the sender.

Next, process 1600 proceeds to block 1606, where the validation units validate the transmission. A validation unit may be configured to validate the transmission using UTM balance(s) identified at block 1604. The validation unit may be configured to determine whether the UTM balance(s) are sufficiently high to transmit the amount(s) of resource(s) specified in the requested transmission to the set of recipient(s). In some embodiments, a validation unit may be configured to perform other validation steps (e.g., as described herein with reference to FIG. 14B). For example, the validation unit may verify nonce(s) included in message(s) received from the sender and/or the set of recipient(s). As another example, the validation unit may verify that information indicated in a message from the sender matches information in message(s) from the set of recipient(s) (e.g., as part of an atomic settlement scheme).

If the validation units determine that the requested transmission is valid at block 1606, then process 1600 proceeds to block 1608 where the validation units sign messages with respective cryptographic signatures indicating that the transmission is valid. A validation unit may be configured to sign a message with a cryptographic signature (e.g., generated using a private key of the validation unit). Next, at block 1610, the validation units transmit signed messages to a device (e.g., that requested the transmission). Although not illustrated in FIG. 16, the validation units may subsequently receive a validation certificate (e.g., if a threshold number of validation units validate the transmission or the validation units reach a consensus that the transmission is valid) and, in response, execute the transmission.

If the validation units determine that the requested transmission is not valid at block 1606 (e.g., because the UTM balance(s) are insufficient, or request message(s) do not include valid information), the process 1600 proceeds to block 1612, where the validation units may transmit indications that the transmission is invalid. For example, a validation unit may transmit a message to a device indicating that the requested transmission is invalid.

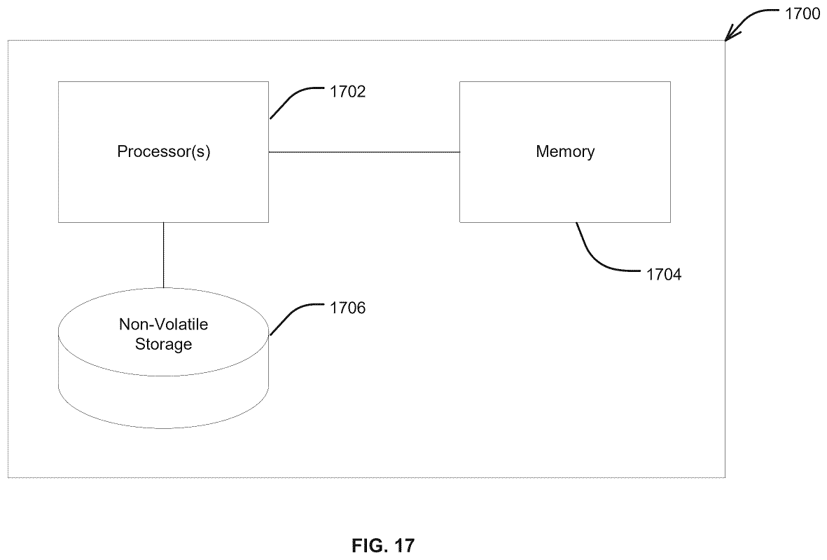

FIG. 17 is an example computer system 1700 that may be specially configured to perform embodiments of the technology described herein. The computing device 1700 may include one or more computer hardware processors 1702 and non-transitory readable storage media (e.g., memory 1704 and one or more non-volatile storage 1704). The processor(s) 1702 may control writing data to and reading data from (1) the memory 1704; and (2) the non-volatile storage device(s) 1706. To perform any of the functionality described herein, the processor(s) 1702 may execute one or more processor-executable instructions stored in one or more non-transitory computer-readable storage media (e.g., the memory 1704), which may serve as non-transitory computer-readable storage media storing processor-executable instructions for execution by the processor(s) 1702.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

### Example Implementations of Some Embodiments

In one example implementation, a cryptographic transmission system may be used as a payment system referred to as FinalPay. In the payment system, transactions are final after a consistent broadcast of a valid transaction. Broadcast-based payment systems offer equivalent security guarantees to consensus based blockchains (Byzantine fault tolerance, BFT), but achieve faster finality and are highly scalable through node-level sharding (recent experiments demonstrate 100k+TPS at ˜100 ms latency until finality). In some embodiments, the system features an account model that is fully compatible with Ethereum/Metamask, transaction fees that are redistributed to validators, account recovery, checkpointing, committee reconfiguration, and governance. Validators are permissioned and the protocol enforces compliance with banned account regulations. In some embodiments, there is no staking requirement, no slashing, and no proof-of-work. Validators are rewarded proportional to participation but without money creation. The native token is exclusively created through a central mint (e.g., an operator unit) agreed on by validators, and can also be bridged to other chains as an ERC-20 or equivalent token. Some embodiments implement an asynchronous solution for account recovery that does not affect finality or latency. Another limitation of existing broadcast-based payment systems is fixed committees. Some embodiments present a solution for updating the validator set that also allows voting on governance changes and creating checkpoints. The governance and the checkpointing systems do not interfere with the finality of payments. Some embodiments prove the safety and liveness of FinalPay under Byzantine faults.

In some embodiments, FinalPay consists of three sub-systems, a payment system, a checkpointing system and a governance system. The payment system allows users to issue payment transactions, it also provides cancellation and account recovery features that ensure liveness for all accounts. The governance system partitions transactions into epochs, checkpoints further partition the transactions within an epoch. Importantly, the assignment of transactions to epochs and checkpoints happens retro-actively. Epoch transitions and checkpoints do not interrupt the processing of payments and they do not affect their finality. Valid payments are immediately final after completing a consistent broadcast of the transaction. This near-instant finality allows for extremely low latency and gives the system its name. Some embodiments include a governance system to allow making changes such as adding or removing validators or changing fees and other protocol parameters. Epoch transitions necessitate creating a checkpoint, where validators agree on the state of the system up to a certain point. Some embodiments separate out the checkpointing system to allow making checkpoints even when no governance changes are due. This is to support the operation of the system at high loads: experiments have shown that systems using the same broadcast primitives as FastPay can support over 100k transactions per second (TPS). At such rates, keeping all transactions in memory would quickly become untenable. Checkpoints allow discarding old transactions from memory, thus ensuring that the system can remain operational at sustained high loads. In some embodiments, both checkpoints and epoch transitions are possible to complete within seconds (not counting the bootstrap time for newly joining nodes), some embodiments checkpoints when certain memory thresholds are met, likely resulting in multiple checkpoints per day, while only making governance changes on an ad-hoc basis at a likely much lower frequency.

Some embodiments implement a version of FinalPay where validators need permission by an operator (sometimes referred to as proof-of-authority) and money creation is controlled by the operator. It may be noted that FinalPay could also be implemented with various other design choices, e.g. a permissionless cryptocurrency using proof-of-stake, or combined with smart contracts.

In some embodiments, examples of roles and actions include:
a. Account owner: send and receive transactions; account owners have three ways to interact with the system: they can either query a pull notification about the current state from a validator (trusted for liveness) and then broadcast a transaction themselves, or they can use one of the following options:
   i. Wallet: a light-weight software client that can send transactions and subscribe to push notifications for selected accounts.
   ii. Mirror or archive mirror: subscribes to all message notifications and keeps track of the full state, either since the last checkpoint (mirror) or since genesis (archive mirror); responds to state queries by any party.
   iii. Relayer: a special service that relays payments on behalf of an account (only needs to be trusted for liveness).
b. (Standard) validator node: checks submitted payment transactions for correctness, signs correct transactions, keeps a log of transactions since the last checkpoint, signs governance proposals, votes in consensus (required for checkpointing).
c. Archive node: a validator node that keeps a log of all transactions since the beginning; running a validator node as an archive is optional and it provides full audibility; it is voluntary and the protocol does not punish validators for running only a standard node.
d. Operator: mints and burns the native token, issues governance proposals for the next epoch.

In some embodiments, example message types include:
a. Payment: send native token funds from the sender to a list of recipients.
b. Cancellation: allows cancelling payments that have not yet reached a quorum (typically because the sender does not have sufficient funds).
c. Recovery: byzantine behavior by the sender can in rare cases lead to the account getting locked, this transaction type allows recovering such accounts.
d. Governance: lays down protocol parameters (including the list of validators) for the next governance epoch; a minor related message type is KeyRotation that validators can send to the operator to ask them to use a new signing key or account address for them in the next epoch.
e. Checkpoint: a snapshot of the current state of each account, including newly distributed transaction fees that are credited to validators'accounts.
f. Subscribe: request to be included in broadcasts for specified message types.
g. Query: request information about any aspect of the state.

In some embodiments, a payment message may have the following example elements:
a. Sender: the sender's address
b. [Recipients]: an array of recipient addresses
c. [Amounts]: an array of unsigned 256-bit integers corresponding to the amounts sent to each recipient (the length of the lists has to match)
d. Nonce: counter of transactions sent by that account
e. Data (optional): allows appending extra information regarding the transaction
f. Signature: a hash of the above data, signed by the sender

In some embodiments, validators who sign the transaction include the following fields:
a. Epoch: the current epoch ID (validators include this in the data they sign—so validators' signatures are always valid for one epoch, while the transaction data above signed by the sender is valid indefinitely).
b. Checkpoint: the current checkpoint ID (validators include separate checkpoint and epoch IDs because governance and checkpointing happen independently).
c. Signature: a hash of the transaction, concatenated with the epoch ID, signed by the validator.

In some embodiments, the presence of the following field makes the message a payment certificate:
a. Signatures: an aggregate representation of a quorum of signatures by the current epoch's validators.

In some embodiments, a governance message has the following example elements:
a. Epoch: the epoch ID for the next governance epoch (epoch IDs always increment by one).
b. [Validators]: an array of public keys, account addresses and IP addresses of the validators for the next governance epoch and a Boolean indicating whether the validator self-declares to be an archive node.
c. Operator: the public key for the operator for the next governance epoch.
d. Mint: the account address for this epoch's mint account.
e. [Banned]: an array of account addresses that are not allowed to effect transactions (this may be replaced by a reference to such a list, e.g., a URL).
f. Parameters governing the protocol (our suggested starting values in parentheses): TxFee ($0.01), CancellationFee ($0.02), RecoveryFee ($0.03), inTxToCheckpoint (expected number of transactions per day) and OperatorFeeShare (20%).
g. Version: a reference to a canonical implementation of the protocol for the next epoch (e.g., a link of a tuple to a git repository, a commit hash and a hash of the repository's content).

In some embodiments, the presence of the following example fields makes the message governance certificate:
a. Signatures: an aggregate representation of signatures of a hash of the above data signed by a sub-quorum of the previous epoch's validators; validators use the private key corresponding to the public key contained in the [Validators] array to sign this message; validators who changed their signing keys from the last epoch include a separate signature of their new key signed with their old key.
b. Signature: a hash of the above data, signed by the last epoch's Operator

Some embodiments may use other messages in addition to or instead of the example messages described herein.

In some embodiments, each validator (standard and archive nodes) V keeps a copy of the current system state in memory, consisting of:
a. Keys: the private keys corresponding to the public key and to the account (validators can use different spending and signing keys) included in the current epoch's governance message for V.
b. [Epochs]: an array of tuple of governance certificates for all epochs from the beginning up to the current, and an integer denoting the amount of yet undistributed transaction fees for transactions that have already been checkpointed with a certificate referring to that epoch (always in the range from 0 to one less than the number of validators in that epoch).
c. Checkpoint: contains a copy of the Accounts state at the last checkpoint (only the Nonce and Balance fields), the ID of the last checkpoint and its hash.
d. Subscriptions: all subscription requests received (that have not expired yet).
e. [Transactions]: an array of transaction (payment, cancellation and recovery) certificates seen by V since the last checkpoint.
f. [Archive] (only for archive nodes): an array of all transaction certificates from genesis up to the last checkpoint
g. Accounts: a mapping from account addresses to the data for each account.

In some embodiments, the state of an account A kept by the validator V may include the following:
a. Key: the public key for the account.
b. Nonce: an unsigned integer representing the number of payment certificates sent by A seen by V.
c. Balance: unsigned integer representing the balance of the account (in $ cents); balances are increased if payments are received or the account is a validator account receiving transaction fee rewards, and decreased through outgoing payments; the balance of the current epoch's mint wallet is always 0 by definition.
d. [Pending] (if applicable): an array of valid payment messages sent by A that have not been signed by V yet and no certificate has yet been seen by V.

In some embodiments, a protocol defines the rules for transitions on the state, e.e., all actions available to the different roles. In some embodiments, a committee or a set of validators or nodes (these terms interchangeably) is always valid for an epoch. Some embodiments make the standard assumption that >⅔ of the validators in any epoch are always correct in adhering to the protocol. Some embodiments index epochs by e, and refer to the validator set for an epoch as Ve and the maximum allowed number of faulty nodes as fe, or f where the context is clear. In some embodiments, any subset of at least 2fe+1 validators for an epoch as a quorum, and any subset of at least fe+1 validators as a sub-quorum. The term certificate may refer to any message that includes signatures by a quorum of validators for the contents of the message. In the context of creating certificates, some embodiments aggregate signatures in general. In practice, one can distinguish between identifiable aggregation, which allows identifying the validators who contributed to a certificate, and anonymous aggregation, which does not. The protocol is valid with both kinds, only assuming that non-interactive aggregation is used. The choice between identifiable and anonymous aggregation has implications for the ability to monitor node participation and for performance. To give some examples, a list is arguably the simplest form of identifiable aggregation, while BLS signatures are standard for anonymous aggregation (and have the advantage of consuming the same space as a single signature).

In some embodiments, an example process for making a payment may be as follows:
a. Sign: a sender initiates a payment by creating and signing a payment message.
b. Broadcast: the sender, or anyone on their behalf, sends the signed payment message to all validators.
c. Countersign: validators who receive a payment message verify that it is valid: it must be correctly formatted and the nonce must be exactly one greater than the last nonce and the account must have a sufficient balance to pay for all amounts sent plus all transaction fees, according to the governance certificate for the current epoch; if the message is valid, and no other transactions with the same nonce by that sender are currently stored as pending, the validator signs the message and together with the current checkpoint ID and epoch ID, and sends it back to the sender; signed transactions and transactions with an insufficient amount or a too high nonce are stored in [Pending]; if nodes see a too high nonce, they query random other nodes to confirm whether they have missed any transactions
d. Finalize: the message is final as soon as the sender, or anyone, sees a quorum of signatures; they aggregate the signatures, creating a payment certificate and send it to all validators
e. Accept: validators accept a payment when they see a certificate; they add it to their Transactions array and record the effects of the payment and the transaction fees in their Accounts; if they had previously stored the message as pending, they remove the pending message

In some embodiments, only the first step—signing the transaction-requires participation by the sender. In some embodiments, anyone who sees that a payment has reached a quorum of signatures (4) knows that its finality is guaranteed, even before validators have accepted it (5). This can be used to reduce latency even further, by sending the certificate to the recipient before it is sent to validators. A payment transaction can have arbitrarily many recipients. Sending payments to multiple recipients guarantees atomicity (all payments are executed simultaneously, if the transaction is correct, or none are executed) and reduces latency (all transactions clear at the same speed as a single one, instead of one after another), but does not reduce transaction fees (the sender pays G.TxFee for each entry in P.Amounts, even if multiple amounts are sent to the same account).

In some embodiments, minting and burning the native token takes the same form as regular payment transactions. Mint transactions are payments where P.Sender==G.Mint and burn transactions are payments where P.Recipients[i]==G.Mint for some i. The processing of mint and burn transaction differs from regular payments in that the balance of the mint wallet is always zero, so burn transactions do not increase it and mint transactions of any amounts are valid despite the balance being zero. In some embodiments, no transaction fees are deducted or distributed to validators for mint and burn transactions.

In some embodiments, one remarkable aspect of the payment system is that it produces a very low number of messages (e.g., validators do not communicate with each other). It makes sense to provide an option for other parties to subscribe to messages about state changes—going beyond the minimal number of required messages enables several services that improve user experience: Relayers take over messaging on behalf of a sender (another remarkable aspect is that once the payment has been signed by the sender, the required messaging can be performed by anyone). They broadcast it to everyone, aggregate the signatures in the responses and broadcast the certificate again, including to the sender. They also keep a copy of the full state, similar to (standard) validators, to be able to answer queries about account balances. A relay service can implement the Ethereum execution engine API and thus serve as an RPC provider that can be added e.g., to Metamask. Mirrors keep a copy of the state, similar to a validator relayer, but without performing validator or relayer services. They can be used e.g., to provide necessary information for ‘block explorer’ applications. Wallets are software clients that can be implemented by anyone as direct payment apps. In order to perform these services, they need different information (up-to-date, although none of the services will critically fail if they have not received the latest updates): relayers and mirrors both need to receive all certificates, to be able to fully represent the current state. Wallets need to receive all payment certificates containing selected accounts either as a sender or recipient (and checkpoint certificates where the account is a recipient of transaction fees), to be able to represent current balances for those accounts. Parties may request to be notified about certain events for a limited amount of time. It is up to whoever sends a message to decide which of those requests to honor, our recommendation (that will be coded up as the default behavior in the node client software) is to honour all such requests that provide a valid justification (running one of the services mentioned above, except if it has been observed in the past that the requester does not actually perform those services) and that have an expiry date no more than four weeks into the future. The behavior is then to simply include those parties in addition to the validators whenever a message of the requested type is broadcast. Subscribe messages S take the following form:
a. [Messages]: an array specifying the types of messages to receive; these can be payment, governance, and checkpoint certificates; parties may also specify to only receive payment and checkpoint messages relating to certain accounts.
b. Expiry: a UNIX date that should lie no more than four weeks into the future.
c. Justification: subscribers can specify whether they are running a relayer, mirror, archive mirror or wallet service.

One problem with the payment system as described above is that Byzantine behavior by the sender can lead to their account getting permanently locked. This can happen if the sender signs different transactions with the same nonce and sends it to different validators. If enough validators sign different messages with the same nonce, it can lead to a situation where it is no longer possible to reach a quorum for any of the messages. Since validators can also not sign any new messages with a higher nonce, this means that the account is effectively locked forever and the funds in the account can no longer be moved.

Some embodiments address this issue by introducing a new kind of recovery certificate R. A recovery certificate contains an array of messages with the same nonce, together with their signatures, that proves that it is impossible to reach a quorum for any of the messages. Concretely, this means that for each member of the recovery transaction set, it must hold true that the unique signatures, with the same epoch, for all the other messages combined form a sub-quorum (a formal definition of a recovery message follows in chapter 3). Similar to payment certificates, valid recovery certificates are immediately final.

In some embodiments, validators who see such a valid recovery message increase the nonce for the affected account and remove any pending transactions they might have for that nonce, thereby making it possible for new transactions by that account to be signed again. That is, if the account has a sufficient balance to pay for the associated fees, G.RecoveryFee (for the last epoch in the set) times the total number of recipients across all messages in R (cancellation messages are counted as having one recipient). The resulting fee is higher than for an honest payment transaction, to acknowledge the fact that it is due to Byzantine behavior by the sender and has created more network load than an honest transaction, but it would usually still be very low in absolute terms (typically below $1).

In some embodiments, signatures for different transactions with the same counter are not the only reason why an account might be unable to effect new transactions. This could also happen e.g., if they have signed a transaction with a payment higher than their current balance—in this case they could not effect new transactions until they have a sufficient balance and the transaction can be processed.

In some embodiments, if account owners do not want to wait for this, our protocol offers a different option: they can send a cancellation message C. A cancellation message has the same fields as a payment message, except for Recipients and Amount. Validators treat it similarly to a payment message, signing it if it is correct, and it becomes a final certificate once it has reached a quorum. The fee for cancelling a transaction, G.CancellationFee, would typically be higher than for a payment transaction, to reflect the fact that it likely generated more network traffic (but again, very low in absolute terms, typically). Another important difference between cancellation and payment messages is that the former take precedence over any pending payment messages—validators can sign a cancellation message, even if they already have pending messages with the same counter for the same account. But they cannot sign a cancellation message if they have already signed some message with the same nonce with any epoch. Cancellation messages may also be included in a recovery message, so there is always a path to unlocking a stalled account (as long as the account has a sufficient balance to pay the fees).

In some embodiments, it is possible that multiple certificates with different validator sets from different epochs exist for the same transaction. So the fees cannot be distributed until there is agreement on a unique certificate for each transaction. This problem is closely related to a different one, that of creating a checkpoint. In a checkpoint, validators agree on the current state, allowing them to discard all previous transactions from memory, thus addressing the issue that storage requirements grow linearly in the number of transactions. This problem is known in the literature as a consistent global snapshot, but our problem features some additional complexities that stem from the interplay between the asynchronous payment system and the requirement that the finality of payments shall not depend on consensus, as well as the possibility of committee reconfiguration. Any consensus algorithm could likely be adapted to this problem. Some embodiments use a leaderless snapshot algorithm that addresses all our requirements:
a. Initiate: Any node observing that length of the [Transactions] array in its local state matches G.MinTxToCheckpoint for the current epoch creates a checkpoint proposal: it creates a temporary copy of its current [Transactions] array, [Transactions'], creating an efficient representation for it2. It signs the hash of the transactions concatenated with the current checkpoint and epoch IDs, and sends this signed proposal to all validators. The validator also includes a copy of each transaction it has signed, but for which it has not yet seen a certificate in its initial proposal. At the same time, it stops signing transactions with the current checkpoint ID and seamlessly starts signing with the next checkpoint ID (transactions that were signed with the old checkpoint ID may be signed again with the new checkpoint ID, similar as for epochs).
b. Propose: A node who has not yet sent out a checkpoint proposal and receives the first such proposal first verifies it for syntactical correctness: syntactically correct proposals include at least G.MinTxToCheckpoint transactions, they increment the last checkpoint ID by one, it contains only transactions with correct certificates with checkpoint IDs up to the last one, and those transactions increment the sender account nonces by one (with respect to the state in the last Checkpoint, not in the current Accounts). Upon the first correct proposal received, a node switches to signing transactions with the next checkpoint ID, just as the initiating node. The receiving node creates the union set of the transactions in its own [Transactions] array and of those in the received proposal. This becomes its own version of [Transactions'], for which it sends out its own signed proposal. In the first proposal, validators also include a copy of each transaction they have signed, but for which they have not yet seen a certificate.
c. Re-Propose: After they have sent out their first proposal, nodes continuously monitor, process and store incoming proposals. Any proposals that contain transactions not included in the node's previous proposals get added to [Transactions'] and trigger a new checkpoint proposal sent by that node (any new proposal sent by a node must contain a true superset of transactions compared to its last proposal—this is another correctness check performed by all receiving nodes). Validators immediately apply the effects of transactions that were not included in their own Transactions array to the Accounts in their state.
d. Checkpoint proposals are also triggered if a new governance proposal is made, and checkpoint proposals that include a new governance certificate are syntactically correct independently of whether they contain G.MinTxToCheckpoint transactions. Validators treat such a proposal similar to how they treat any other proposal. If they have not yet seen a proposal with the same epoch and checkpoint IDs, they treat it as a new initial proposal. If they have already made a checkpoint proposal, they create the union between their last checkpoint proposal and the new one, and if the governance proposal contains any new transactions, they trigger a new checkpoint proposal, just as they would with any received checkpoint proposal.
e. Process: validators process a checkpoint once they observe a quorum of signatures for a proposal (with respect to the epoch referenced in the proposal). They apply the transactions in the checkpoint to the state at the last Checkpoint in their state, creating a new temporary variable Checkpoint′, and record the effects of distributing transaction fees to validators' wallets—the exact process for the latter is laid out below.
f. Lock: After having processed the checkpoint, validators hash the state of the accounts in the Checkpoint′ and sign it. They send out a lock message containing their signature of the checkpoint hash, as well as the aggregated signatures for the proposal and the transactions contained therein.
g. [if required] Unlock: if a validator sees that different lock messages have gathered enough signatures each, such that neither can reach a quorum, they construct an unlock message. Unlock messages contain a proof that a quorum is impossible, analogous to a recovery certificate (see sub-chapter 2.3). They also attach a new checkpoint proposal containing the union set of all transactions in the unlock message. Validators who see this message treat it like they treat any proposal, and the protocol moves back to the re-propose phase.
h. Confirm: a node considers a checkpoint confirmed as soon as it sees a quorum for a lock message, or a certificate containing such a quorum. If a node has not yet seen a certificate, it creates one and sends it to all nodes.
i. Finish: following confirmation, validators process the transactions without a certificate that they have received in the initiate and propose steps, taking the union set of all such transactions. There are three possible cases for those transactions: (i) they have already received a quorum of signatures, in this case, they aggregate the signatures and add the certificate to their own [Transactions] array. (ii) They may see different transactions with the same nonce, in this case, they consider the account Byzantine and will only accept cancellation or recovery messages from this account going forward. (iii) Or they may see that a transaction has gathered some signatures in the previous period, but not enough for a quorum. In this case, they sign that transaction with the new checkpoint ID and, if the confirmed proposal includes a governance certificate, the new epoch ID. After they have finished processing all transactions, they send out the newly signed transactions to all validators and to the sender.

In some embodiments, upon confirmation of a checkpoint, validators replace their Checkpoint with the new Checkpoint′, apply the effects of fee distribution and any transactions in the checkpoint that were not yet reflected in their state to the Accounts in their state and discard the checkpointed transactions from their [Transactions] array; archive nodes add them to their [Archive]. They immediately stop signing messages with the old checkpoint ID and start signing with the new one. Validators may sign transactions that they have already signed with an old checkpoint ID, but for which they have not yet seen a certificate, again with a new checkpoint ID. This helps ensure liveness, but it may result in multiple certificates existing for the same transaction. A unique certificate for each transaction will be selected when the transaction is checkpointed, ensuring that the associated transaction fees are only paid out once.

In some embodiments, transaction fee distribution could happen in many different ways. The reward mechanism is important to ensure incentive alignment, e.e., making sure that only validators who actually contribute to the protocol get rewarded. This is where identifiable signature aggregation, mentioned in chapter 1 can be of help: it allows validators to see which other validators participated in signing certificates. This could be used to design a proof-of-participation reward model, where validators are rewarded proportional to how many of their signatures are contained in the checkpoint. The governance mechanism makes such complex calculations superfluous, as it allows validators to agree on removing nodes who do not participate in signing transactions. Some embodiments use a simpler fee distribution mechanism that distributes fees equally among all validators in an epoch, while subtracting a fixed percentage cut as the operator fee share (which effectively gets burnt): validators use the governance certificates corresponding to each epoch to compute the transaction fees available for redistribution for each epoch contained in the checkpoint. In case multiple certificates for the same transaction exist, validators must use the one with the lower resulting fees for the user (this has important safety implications), and among those with the same transaction fees the one with the lowest epoch number. They add the newly available fees to the currently undistributed fees according to their [Epochs] array. Call this sum Fees—then the amount that is credited to each validator for the respective epoch is then given by an equation, where the operator fee share is interpreted as a percentage, and any remainder is stored in the [Epochs] array again. It is worth noting that even if anonymous aggregation is used, there exist other ways to collect data on validator participation, e.g., at relayers.

In some embodiments, one modification to the transaction fee distribution would be to distribute fees only for the current epoch, meaning that the transaction fees for transactions checkpointed after their epoch would de facto be burnt, which is similar in effect to a slightly higher operator fee share. The benefit of this design would be that validators would not have to store governance certificates and undistributed fee amounts for all previous epochs, avoiding linear growth in memory requirements. A compromise would be to store governance certificates for a fixed number of previous epochs, reflecting the fact that it becomes increasingly unlikely that old transaction certificates still appear.

In some embodiments, protocol governance fulfills several functions: updating the validator list as validators enter and leave, allowing validators to rotate keys, updating fee parameters to ensure economic viability, updating the list of banned accounts to ensure compliance or updating the software for maintenance or to bring in new features. Governance certificates increment the epoch ID once they become effective. The process for an epoch transition involves making a checkpoint and it can be thought of as a checkpoint where, in addition, governance parameters may change. The reason some embodiments create a separate sub-system for epoch transitions is that checkpoints are meant to be done regularly to support the operation of the protocol. By separating the two processes, some embodiments gain that the agreement process on governance proposals does not impact the operation of the rest of the system, including the checkpoints.

In some embodiments, the union set all=Ve∪Ve+1 of all validators in the previous and the next epoch can be partitioned into {old, new, out}, where old=Ve∩Ve+1 is the set of validators who remain on the committee, new=Ve+1\Ve is the set of newly added validators and out=Ve\Ve+1 is the set of removed validators. The process for an epoch transition for the validators in Ve looks as follows:
a. Initiate: The operator creates a governance proposal G for epoch e+1, signs it, and sends it to all nodes in Ve.
b. Sign: Validators in Ve sign G and send it back to the operator.
c. Confirm: After G has reached a quorum, the operator aggregates the signatures and sends out the resulting governance certificate to validators in Ve, triggering a checkpoint. Any validator who sees this immediately stops signing any transactions with the current checkpoint or epoch ID.
d. Send: after the checkpoint is finished, validators in Ve send new validators the governance certificate, the confirmation certificate for the checkpoint, the certificates for all transactions they may have that are not included in the last epoch's checkpoint, and a copy of each transaction they have signed, but for no certificate was included in the checkpoint.

In some embodiments, only old validators commence signing transactions with the new epoch and checkpoint ID: if the validator set size has remained the same or increased compared to the last governance certificate, old validators immediately start signing transactions with the new governance and checkpoint IDs. There is no pause after confirming the governance certificate. If the validator set size has reduced, they stop signing any messages and start buffering incoming transactions while the checkpoint process is ongoing. In this case, they wait until they have finished the checkpoint to start signing transactions with the new checkpoint and epoch IDs, incrementing both IDs.

In some embodiments, validators may also use the governance process to rotate their signing keys. They may use a KeyRotation message (consisting of the old and new key and signed with both keys) to inform the operator of this intent, who will include their new key and remove their old one from G. These validators participate in the process with their old key and follow the same process as members of old. new validators perform bootstrapping:
a. Query: as soon as they receive the first governance certificate, they start querying random validators in Ve to receive a copy of the full state at the referenced Checkpoint.
b. Confirm: they wait until they have received a quorum of governance certificates to confirm that they have received a copy of the correct checkpoint (the checkpoint itself can be verified by its hash included in the confirmation certificate).
c. Process: following confirmation, new validators create the union set of all transaction certificates that they have received, thus creating their initial [Transactions] array. They also apply the effects of these transactions to the state in the Checkpoint, thereby creating their initial copy of Accounts. Regarding the signed transactions without certificates, new validators perform the same routine as in the finishing step of a checkpoint. Only then do they start signing new transactions.

In some embodiments, client software comes in different forms, for the various roles in the system (validators and mirrors with or without archives, relayers and wallets). Crucial to the correctness of the protocol and its implementation is the software run by validators. Some embodiments implement this client in Rust, a modern language that emphasizes security and speed, making it ideal for our use case. Rust is also favored by other recent blockchain projects emphasizing high capacity and fast finality. The software for a mirror client is similar to that for a validator, the main difference being that all active functions such as signing payments are disabled.

In some embodiments, compatibility with the Ethereum Virtual Machine (EVM) is a usability consideration that is important for adoption. What this means concretely, in the absence of smart contracts, is that it is possible to issue payment transactions on the native system using Metamask and similar software. From a technical perspective, this requires implementing the relevant parts of the Ethereum execution JSON RPC API (this includes endpoints such as eth sendTransaction—see the API specification, documentation and code as well as the Metamask developer documentation). Exposing this API will be the job of the relayers (which could be coupled with running a validator node but need not be)—the relayer client will implement the Ethereum API and any live instance can serve as the RPC endpoint that users can add to Metamask, as they would add any other EVM-based alt-chain (Polygon, Avalanche C-Chain, Arbitrum, . . . ). Another element of EVM-compatibility is that some embodiments will use the same elliptic curve signature scheme as Ethereum and account addresses that consist of the last 20 bytes of the Keccak-256 hash of the public key. This means that users can use the same accounts/keys that they may already be using in Metamask for Ethereum and other EVM chains. This has two important implications. The first is a legal one, namely that the list of banned accounts for our system will be the same as for Ethereum (i.e., the OFAC list). The second concerns post-quantum security.

In some embodiments, relayer services are trustless and can be offered by anyone. At least one such service should be offered by the operator to guarantee that Metamask users have an available RPC endpoint, that can use the revenues from the operator fee share to finance its operation. Wallet software serves to integrate payments on the native system with other apps and is intended to be implemented by different parties. The required implementation effort is low, mainly consisting of providing users with means to sign payment messages, either on behalf of an account owned by the app's operator or on behalf of user's accounts. Any third-party app that integrates payments on the native system would fall in this category.

In some embodiments, the only element that is crucial for post-quantum security in a design are the signatures—here some embodiments may use post-quantum-secure signatures from the start. Some embodiments will support the same elliptic curve as Ethereum. It can be assumed that Ethereum will switch to a post-quantum resistant scheme once quantum security does become a real concern. Some embodiments provide an optional field where senders can specify the signature scheme they used, which provides maximum flexibility for supporting multiple signature schemes, including quantum-resistant ones, from the start.

In some embodiments, broadcast-based payments are “embarrassingly parallel”, and this can be exploited through node-level sharding. This is a technique where each validator runs multiple machines, allowing them to parallelize the processing of transactions. This is necessary because the bottleneck in such systems is, effectively, no longer the consensus mechanism (as in most established blockchains) but the limitations of the hardware—a single CPU core will struggle to handle 100k+ transactions per second, even with a centralized database design. Recent experiments have shown that node-level sharding can be used to increase throughput almost linearly, with the latest records standing at over half a million TPS.

In some embodiments, another usability feature for users is the ability to use the native token as an ERC-20 token on Ethereum, or its equivalent on other chains. The “canonical” representation of the token created by the mint wallet has the same quality as the original tokens on the native chain and is fully backed by balances on the native chain. The service can be offered permissionless, using the same signature scheme as for payments on the respective underlying chain from which funds are being sent. Fees on the destination chain are paid for by the sender using the native fee mechanism, and fees on the target chain are subtracted from the transferred amount by the operator (meaning that there will be a minimum transfer amount). An API service by the operator can be integrated into web/mobile apps.

In some embodiments, full consensus is not needed to maintain a payment system with BFT guarantees. Unlike smart contract transactions, payment transactions need not be totally ordered to achieve finality. This opens up the path to more scalable BFT payment systems than Bitcoin, which totally orders transactions and suffers from low throughput, high latency and a lack of finality. Systems that do not apply total ordering can finalize valid payments asynchronously with a single instance of Byzantine reliable broadcast or Byzantine consistent broadcast of a signed transaction. The latter involves no direct communication between validators, substantially reducing the number of messages required and the time to finality compared to consensus-based blockchains.

Some embodiments rely on a fixed validator set. Some embodiments also perform extensive performance evaluations using a Rust-based client operating in a globally distributed system. They report capacity levels of around 100k TPS with latency around 100 ms and high resilience to node failures. They compare the impact of BLS signature aggregation, which adds computation costs but reduces message size to O(1) in the number of validators (and destroys information that is useful for monitoring validator participation). They find that below a cut-off of about 100 validators, sending unaggregated signatures offers better performance than signature aggregation. They also examine performance gains due to node-level sharding, showing capacity increases to 160k TPS with negligible impact on latency.

Some embodiments provide an account-based payment system, based on BCB, with checkpointing and transaction fees, that addresses several limitations faced by the above systems. Some embodiments address a liveness issue that plagues all of the broadcast-based systems: faulty behavior by a sender may, in some cases, lead to their accounts getting permanently locked and unable to effect any transactions in perpetuity. Conventional works argue that account locking is not a problem as it is due to faulty behavior on the sender's part. Some embodiments allow account owners to recover from such faulty behavior. Our solution for account unlocking works fully asynchronously, piggy-backing on the established BCB mechanism. Checkpointing is important to ensure practical operability of the system under high loads, by allowing to discard transactions from memory. It amounts to taking a global consistent snapshot. Some embodiments allow continuing to process transactions without interruption if a snapshot is taken. Some embodiments do not force transactions for which processing started before the checkpoint to be finished before the checkpoint. For epoch transitions, some embodiments combine this snapshot algorithm with a committee reconfiguration. This is critical because committee reconfiguration generally requires consensus for safety before transaction processing can continue. Some embodiments guarantee safety in cases (notably, when the validator set size does not shrink) even if not all transactions from the previous epoch are included in the consensus. This means that, at least when the size of the validator set does not shrink, the processing of transactions need not be paused for committee reconfiguration. If the validator set size shrinks, some embodiments pause the processing of transactions until all transactions from the previous epoch have finished processing. Further features that are important for using FinalPay as a real-world payment system, and that are rare or novel among broadcast-based BFT payment systems, are charging and redistributing transaction fees, governance, and provisions for complying with banned account regulations.

Ephemeral nonces and governance alternatives of some embodiments: in some embodiments, nonces, as used in Ethereum's account model, have some drawbacks with regard to memory requirements. Storing nonces requires more memory than storing only balances, and since nonces are not reset after a checkpoint or epoch change, they have to be kept in memory even for inactive accounts. This could be avoided by making the checkpoint and/or epoch ID part of the transaction that is signed by the user. This means that signed transactions are only valid within one epoch and checkpoint, and nonces can be reset to zero after a checkpoint or in a new epoch. EVM-compatibility could be preserved in this model by using some of the leading bits of the 256-bit EVM nonce for epoch and checkpoint IDs, and only the remaining bits for the transaction counter. It would also include pausing the processing of transactions on each checkpoint and ensuring that all transactions from the last epoch are collected before the new one starts. This can be achieved within the presented snapshot algorithm by asking validators to sign and broadcast any valid transactions which they first see during the proposal phase. Other possible changes to the signature system include merging checkpoints and epoch transitions into a single operation or not requiring a vote by validators on governance proposals, allowing governance proposals by anyone or not requiring an operator signature for checkpoint proposals and including them in the consensus instead.

Smart contracts of some embodiments: in some embodiments, while FinalPay was optimized for payments with instant finality, it is possible to combine it with smart contract transactions while preserving instant finality. Smart contract transactions require total ordering of transactions and thus consensus, hence smart contract transactions can only be processed during checkpoints. Some embodiments enable payment finality before a checkpoint is confirmed because both payments and smart contract transactions can spend user's funds. To ensure that any payment with a certificate is valid independently of what happens in smart contract transactions, all payments should be included in a checkpoint and payment processing paused on checkpoint transitions as in the ephemeral nonce model above. But this alone may not be sufficient to guarantee finality, as payments also compete with smart contract transactions within the same checkpoint period. Some embodiments mitigate this by choosing any deterministic rule that gives priority to payments over smart contract transactions in a checkpoint, such as sorting all payments before smart contract transactions in the total ordering. Whether smart contract transactions fail or succeed then depends on the balances after all payment transactions within a checkpoint have been processed.

Alternative consensus mechanisms of some embodiments: in some embodiments, the snapshot algorithm used in the checkpoints could be replaced with any number of consensus mechanisms. One alternative would be practical Byzantine Fault Tolerance (PBFT). PBFT consensus requires a leader, but pseudorandom leader rotation is sufficient to maintain BFT guarantees, an example of a usable rule would be to cycle through the validator list in the current governance certificate. Having a leader allows skipping the re-propose and unlock phases but requires a separate leader change process, where validators agree on the next leader after a pre-defined time-out period. In case completeness is required, e.g., for smart contracts, re-proposals are needed again. Other possible consensus mechanisms include exponential information gathering, Tendermint, Narwhal/Bullshark, and generally all BFT consensus algorithms (where authenticated nodes may be assumed in BFT proofs) can be adapted for this use case.

UTXOs and privacy features of some embodiments: in some embodiments, unspent transaction outputs represent an alternative approach to tracking user balances compared to an account model. Transactions consume one or more UTXOs and send the funds that they represent to one or more new addresses, thereby creating new UTXOs. In some embodiments, all elements of FinalPay can be used with UTXOs instead of an account model: payment and cancellation transactions are immediately final once they reached a quorum, and recovery messages can be constructed analogously. Checkpoints agree on the current state of UTXOs, allowing to discard the history, and epoch transitions do not require further adaption. Transaction fees are charged by ensuring that the sum of UTXOs is less than the consumed UTXOs and distributed in a checkpoint by creating UTXOs without inputs. UTXOs may also be created with stealth addresses, where only recipients or parties with whom they have shared their scanning private keys, have the ability to verify the owner account of a UTXO, thereby providing transaction privacy. Other alternatives for providing privacy include signing zero knowledge computation certificates instead of transactions, masking even the existence of balance. Such privacy-enhancing features may also be combined with the ability for e.g., the operator to reveal balances or transactions, e.g., by using threshold signatures.

Transaction reversals of some embodiments: in some embodiments, the ability to dispute payments is an important safety feature in modern payment systems. This can be achieved by either delaying finality until some pre-defined conditions, e.g., elapsed time or operator approval are met, or by granting the operator the ability to create new transactions from any account that have the effect of reversing transactions. Granting such abilities requires substantial trust in the operator and should be accompanied by a strong governance framework.

Different wallet designs of some embodiments: the reliance on a single, private key creates risks regarding both the safety and the recoverability of those keys: if a key is not sufficiently secured by the user, anyone who obtains it can issue transactions as if they were the account owner and potentially steal all funds. Conversely, if a key is kept very securely but then lost by its owner, they lose the ability to access their funds. Secret sharing is a cryptographic technique that allows mitigating those risks by splitting up a secret into n parts such that any size-k subset can be used to restore the full secret, where both k≤n∈N+ can be chosen arbitrarily. Secret sharing makes use of the mathematical fact that any degree-(k−1) polynomial over the reals can be fully and uniquely reconstructed using k distinct points on the polynomial. It works by simply sharing n distinct points on a degree-(k−1) polynomial whose coefficients encode the secret in some deterministic scheme. This can be used to improve security by sharing a private key, e.g., among multiple devices, enabling multi-factor authentication, or multi-sig wallets, where multiple parties need to agree to a transaction. Multi-sig schemes could be used, eg, to require committee approval for transactions, or to task a separate entity to monitor transactions for fraud risk, and to only provide a signature if the risk is deemed sufficiently low (potentially coupled with an insurance product). Secret sharing can also be used to address recoverability risks, e.g., by designating a set of trusted parties who can collectively authorize changing the public key of a wallet (or, equivalently, moving the funds to a new account). Both multi-sig wallets and social recovery can be built as an abstraction by on top of the protocol by a wallet software, or be supported directly by the protocol itself.

Proof-of-stake and decentralization of some embodiments: having an operator is not required for FinalPay and it can also be used to power a decentralized cryptocurrency. Protection against sybil attacks, where attackers create multiple validator identities, is commonly achieved using PoS in decentralized cryptocurrencies, where the >⅔ requirement for a certificate refers to a weighted vote by validators, with weights proportional to staked amounts. Epoch transitions are triggered by special staking and unstaking transactions, where validators lock up their funds in the protocol. Those staking transactions also serve the purpose of communicating the validator's public key. Proof-of-stake can be used in conjunction with a centralized mint, as in our presentation, but different ‘Tokenomics’ that distribute newly created funds to validators according to pre-defined rules are more commonly used. Typically, such rewards are proportional to the stake, and may also include penalties for non-responsiveness or other Byzantine behavior, which can be proved if identifiable signature aggregation is used.

Classic payment systems are usually run by one organization, or by a set of entities who mutually trust each other. The FinalPay protocol may also be useful in such scenarios where malicious attacks by system participants are no concern. In modern systems, work is practically always distributed among multiple processes on the same or on multiple machines. These processes may fail for a variety of reasons that need not be related to malicious attacks, e.g. hardware failures or failed updates. Byzantine fault tolerance guarantees the safety and liveness of the system even in such situations. FinalPay may thus be used as a backend solution for centralized payment systems that enhances security by providing BFT security guarantees, while also substantially increasing the throughput compared to existing real-time gross settlement systems. When FinalPay is used in such contexts, it may be possible to use FinalPay without any transaction fees, at least at the protocol level.

In some embodiments, FinalPay as a payments layer for tokens on other blockchains: FinalPay can also be used as a layer-2 solution to allow for efficient transfers of tokens represented on another blockchain such as Ethereum. In this case, a smart contract on the source blockchain would play a role similar to the operator, issuing minting an burning transactions and charging transaction fees to cover fees for updating the smart contract state on the source chain. Such a smart contract could handle multiple tokens, including e.g. native Ether and ERC-20, with parallel instances of FinalPay to handle payments in each token.

Data storage, and extra features enabled by storage of some embodiments: the transaction system may also include special transaction types that allow users to store extra data, optionally associating them to their accounts. Data storage may be permanent or time-based, and can power various extra features, such as account limits, e.g., for maximum outgoing payment volume per time period as an extra safety feature. Usability features that rely on stored data include e.g., account identifiers, such as hashed mobile phone numbers, which could enable mobile payment apps that allow sending money directly to phone contacts, if they use this feature. Data storage can also be used to support other features such as allowing transaction fees to be paid by other accounts, or to support different wallet designs such as social recovery, mentioned above.

### Summary of Example Embodiments

In some embodiments, the techniques described herein relate to a method of cryptographically securing transmissions from senders to recipients using a network of validation units, the method including: using at least one computer hardware processor to perform: receiving, from a device by the network of validation units, a request for a transmission to at least one recipient requested by a sender; validating, by each of a first plurality of validation units of the network of validation units, the transmission by: determining whether the transmission requested by the sender is valid; when it is determined that the transmission requested by the sender is valid: cryptographically signing a message with a validation signature indicating that the transmission is valid; and transmitting, to the device, a cryptographically signed message including the validation signature; when the device obtains a threshold number of validation signatures from the network of validation units: generating, by the device, a validation certificate using the validation signatures; and transmitting, by the device to the at least one recipient and the network of validation units, the validation certificate, wherein transmission of the validation certificate triggers execution of the transmission from the sender to the at least one recipient.

In some embodiments, the techniques described herein relate to a method, wherein cryptographically signing the message with the validation signature indicating that the transmission is valid includes signing the message with information identifying a current epoch that indicates a set of parameters governing the transmission and/or information identifying a checkpoint representing a set of transmissions by the sender.

In some embodiments, the techniques described herein relate to a method, further including: determining a change to a previous set of parameters governing transmissions, the previous set of parameters indicated by a previous epoch; and in response to determining the change to the previous set of parameters governing transmissions, transitioning from the previous epoch to the current epoch indicating the set of parameters governing the transmission.

In some embodiments, the techniques described herein relate to a method, wherein the current epoch is the checkpoint representing the set of transmissions by the sender and the method further includes: triggering creation of the checkpoint when transitioning from the previous epoch to the current epoch.

In some embodiments, the techniques described herein relate to a method, further including triggering the creation of the checkpoint only when transitioning from the previous epoch to the current epoch.

In some embodiments, the techniques described herein relate to a method, wherein transitioning from the previous epoch to the current epoch includes: receiving, by the network of validation units, an epoch transition proposal to transition from the previous epoch to the current epoch for confirmation by the network of validation units; reaching, by the network of validation units, a consensus that the epoch transition proposal is valid; and transitioning from the previous epoch to the current epoch when the consensus is reached by the network of validation units.

In some embodiments, the techniques described herein relate to a method, further including, including, by the device, information identifying a current epoch and/or a checkpoint in the request sent to the network of validation units.

In some embodiments, the techniques described herein relate to a method, further including: creating a checkpoint for the sender by: removing a record of transmissions executed by the sender from memories of the network of validation units; and storing, in the memories of the network of validation units, a consolidated representation of the transmissions executed by the sender in the memories of the network of validation units, the consolidated representation utilizing less memory for storage than was utilized to store the record of the transmissions.

In some embodiments, the techniques described herein relate to a method, further including: receiving, by the network of validation units, a checkpoint proposal for confirmation by the validation units; reaching, by the network of validation units, a consensus that the checkpoint proposal is valid; and creating the checkpoint for the sender when the consensus is reached by the network of validation units.

In some embodiments, the techniques described herein relate to a method, further including, after receiving, by the network of validation units, the request: receiving, from the device by the network of validation units, a cancellation message indicating a request to cancel the transmission from the sender to the at least one recipient; validating, by each of a second plurality of validation units in the network of validation units, the cancellation message, the validating including: cryptographically signing the cancellation message with a cancellation signature; and transmitting, to the device, the cryptographically signed cancellation message; and when the device obtains a threshold number of cancellation signatures from the network of validation units, canceling the transmission from the sender to the at least one recipient.

In some embodiments, the techniques described herein relate to a method, wherein the request received by the network of validation units includes a nonce associated with the transmission, the nonce having a numerical value incremented with respect to a numerical value of a previous nonce associated with a previous transmission by the sender.

In some embodiments, the techniques described herein relate to a method, wherein the method further includes: receiving, from the device by the network of validation units, a plurality of requests for a plurality of transmissions with associated nonces, wherein the nonces share an identical numerical value; obtaining, by the device from the network of validation units, for each particular transmission in the plurality of transmissions, a set of validation signatures indicating that the particular transmission is valid; detecting, by the device based on sets of signatures received for the plurality of transmissions, a lock condition in which it is impossible to obtain the threshold number of validation signatures for any of the plurality of transmissions; in response to detecting the lock condition, transmitting, by the device to the network of validation units, a recovery certificate indicating that it is impossible to obtain the threshold number of validation signatures for any of the plurality of transmissions; and in response to receiving the recovery certificate, canceling, by the network of validation units, the plurality of transmissions.

In some embodiments, the techniques described herein relate to a method, wherein detecting the lock condition in which it is impossible obtain the threshold number of validation signatures for any of the plurality of transmissions includes: determining that, for each particular set of signature of the sets of signatures received for the plurality of transmissions, a number of signatures in the sets of signatures excluding the particular set of signatures is greater than ⅓ of a total number of signatures that can be obtained from the network of validation units.

In some embodiments, the techniques described herein relate to a method, wherein the set of parameters governing the transmission specify: a list of validation units that can validate the transmission, a list of banned accounts, and/or fees associated with the transmission.

In some embodiments, the techniques described herein relate to a method, wherein the at least one recipient includes a plurality of recipients.

In some embodiments, the techniques described herein relate to a method, wherein the request indicating the transmission to the at least one recipient requested by the sender is signed with a signature of the sender and at least one signature of the at least one recipient.

In some embodiments, the techniques described herein relate to a method, wherein validating, by each of the first plurality of validation units, the transmission includes validating the signature of the sender and the at least one signature of the at least one recipient.

In some embodiments, the techniques described herein relate to a method, wherein the signature of the sender is generated using a current nonce of the sender and the at least one signature of the at least one recipient is generated using at least one current nonce of the at least one recipient.

In some embodiments, the techniques described herein relate to a cryptographic transmission system for securing transmissions from senders, the cryptographic transmission system including: a network of validation units, each of at least some validation units in the network of validation units configured to: receive, from a device, a request for a transmission to at least one recipient requested by a sender; validate the transmission indicated by performing: determine whether the transmission requested by the sender is valid; when it is determined that the transmission requested by the sender is valid: cryptographically sign a message with a validation signature indicating that the transmission is valid; and transmit, to the device, a cryptographically signed message including the validation signature; receive, from the device, a validation certificate indicating that a threshold number of validation units have validated the transmission; and in response to receiving the validation certificate, execute the transmission from the sender to the at least one recipient.

In some embodiments, the techniques described herein relate to a non-transitory computer-readable medium storing instructions that, when executed by a processor of a validation unit of a network of validation units of a cryptographic transmission system, cause the processor to perform a method including: receiving, from a device, a request for a transmission to at least one recipient requested by a sender; validating the transmission indicated by: determining whether the transmission requested by the sender is valid; when it is determined that the transmission requested by the sender is valid: cryptographically signing a message with a validation signature indicating that the transmission is valid; and transmitting, to the device, a cryptographically signed message including the validation signature; receiving, from the device, a validation certificate indicating that a threshold number of validation units have validated the transmission; and in response to receiving the validation certificate, executing the transmission from the sender to the at least one recipient.

In some embodiments, the techniques described herein relate to a method for updating user balances in a cryptographic transmission system based on values in an external system separate from the cryptographic transmission system, the cryptographic transmission system including a network of validation units, the network of validation units each storing a respective data structure indicating balances of a plurality of users in the cryptographic transmission system, the method including: using at least one computer hardware processor to perform: receiving from, the external system, an indication of a first value in the external system associated with a first user of the plurality of users; determining, based on the first value in the external system associated with the first user, a first amount to issue to a balance of the first user in the cryptographic transmission system; and transmitting, to the network of validation units, a first message indicating the first amount to issue to the first user, wherein transmitting the first message causes the network of validation units to update respective data structures at least in part by adding the first amount indicated by the first message to the balance of the first user in the cryptographic transmission system.

In some embodiments, the techniques described herein relate to a method, further including: generating the first message indicating the first amount to issue to the first user at least in part by cryptographically signing the first message with a cryptographic signature of an operator unit designated for initiating amounts in the cryptographic transmission system.

In some embodiments, the techniques described herein relate to a method, further including: receiving from, the external system, an indication of a second value in the external system associated with a second user of the plurality of users; determining, based on the second value in the external system associated with the second user, a second amount to issue to a balance of the second user; and transmitting, to the network of validation units, a second message indicating the second amount to issue to the second user, wherein transmitting the second message causes the network of validation units to update respective data structures at least in part by adding the second amount indicated by the second message to the balance of the second user.

In some embodiments, the techniques described herein relate to a method, further including: receiving, from a device by the network of validation units, a second message requesting transmission of a second amount from the first user to at least one recipient; validating, by each of at least some of the network of validation units, the transmission requested by the second message at least in part by: determining whether the balance of the first user is sufficient to complete the transmission of the second amount to the at least one recipient; and when it is determined that the balance of the first user is sufficient to complete the transmission of the second amount to the at least one recipient: cryptographically signing the second message with a cryptographic signature of the validation unit indicating that the transmission is valid to obtain a cryptographically signed second message; and transmitting, to the device, the cryptographically signed second message.

In some embodiments, the techniques described herein relate to a method, further including performing, by the device: in response to receiving, from the network of validation units, a threshold number of cryptographic signatures indicating that the transmission requested by the second message is valid: generating a validation certificate using the cryptographic signatures; and transmitting, to the at least one recipient and the network of validation units, the validation certificate, wherein transmission of the validation certificate triggers execution of the transmission from the first user to the at least one recipient.

In some embodiments, the techniques described herein relate to a method, further including performing, by at least some of the network of validation units: determining that the network of validation units has reached a consensus that the transmission requested by the second message is valid; and in response to determining that the network of validation units has reached the consensus, updating respective data structures by updating the balance of the first user in the respective data structures and updating at least one balance of the at least one recipient in the respective data structures.

In some embodiments, the techniques described herein relate to a method, further including performing, by at least some of the network of validation units: receiving, from the device, a validation certificate indicating that a threshold number of validation units have determined that the transmission requested by the second message is valid; and in response to receiving the validation certificate, updating respective data structures by updating the balance of the first user in the respective data structures and updating at least one balance of the at least one recipient in the respective data structures

In some embodiments, the techniques described herein relate to a method, further including: generating the first message indicating the first amount to issue to the first user by including, in the first message, information indicating a transmission of the first amount from a sender to the first user.

In some embodiments, the techniques described herein relate to a method, further including: receiving, from a device by the network of validation units, a second message requesting transmission of a second amount from the balance of the first user to the external system; validating, by each of at least some of the network of validation units, the transmission requested by the second message at least in part by: determining whether the balance of the first user is sufficient to complete the transmission of the second amount from the balance of the first user to the external system; and when it is determined that the balance of the first user is sufficient to complete the transmission of the second amount to the external system: cryptographically signing the second message with a cryptographic signature of the validation unit indicating that the transmission is valid to obtain a cryptographically signed second message; and transmitting, to the device, the cryptographically signed second message.

In some embodiments, the techniques described herein relate to a method, further including: in response to receiving, from the network of validation units, a threshold number of cryptographic signatures indicating that the transmission requested by the second message is valid: transmitting a second value, based on the second amount, to the first user in the external system.

In some embodiments, the techniques described herein relate to a cryptographic transmission system including: a network of validation units each storing a respective data structure indicating balances of a plurality of users in the cryptographic transmission system; and at least one computer hardware processor configured to: receive from, the external system, an indication of a first value in the external system associated with a first user of the plurality of users; determine, based on the first value in the external system associated with the first user, a first amount to issue to a balance of the first user in the cryptographic transmission system; and transmit, to the network of validation units, a first message indicating the first amount to issue to the first user, wherein transmitting the first message causes the network of validation units to update respective data structures at least in part by adding the first amount indicated by the first message to the balance of the first user in the cryptographic transmission system.

In some embodiments, the techniques described herein relate to a system, wherein the at least one computer hardware processor is further configured to: generate the first message indicating the first amount to issue to the first user at least in part by cryptographically signing the first message with a cryptographic signature of an operator unit designated for initiating amounts in the cryptographic transmission system.

In some embodiments, the techniques described herein relate to a system, wherein the at least one computer hardware processor is further configured to: receive from, the external system, an indication of a second value in the external system associated with a second user of the plurality of users; determine, based on the second value in the external system associated with the second user, a second amount to issue to a balance of the second user; and transmit, to the network of validation units, a second message indicating the second amount to issue to the second user, wherein transmitting the second message causes the network of validation units to update respective data structures at least in part by adding the second amount indicated by the second message to the balance of the second user.

In some embodiments, the techniques described herein relate to a system, wherein: the at least one computer hardware processor is further configured to receive, from a device by the network of validation units, a second message requesting transmission of a second amount from the first user to at least one recipient; and each of at least some of the network of validation units is configured to validate the transmission requested by the second message at least in part by performing: determine whether the balance of the first user is sufficient to complete the transmission of the second amount to the at least one recipient; and when it is determined that the balance of the first user is sufficient to complete the transmission of the second amount to the at least one recipient: cryptographically sign the second message with a cryptographic signature of the validation unit indicating that the transmission is valid to obtain a cryptographically signed second message; and transmit, to the device, the cryptographically signed second message.

In some embodiments, the techniques described herein relate to a system, further including the device, wherein the device is configured to: in response to receiving, from the network of validation units, a threshold number of cryptographic signatures indicating that the transmission requested by the second message is valid: generate a validation certificate using the cryptographic signatures; and transmit, to the at least one recipient and the network of validation units, the validation certificate, wherein transmission of the validation certificate triggers execution of the transmission from the first user to the at least one recipient.

In some embodiments, the techniques described herein relate to a system, wherein at least some of the network of validation units are configured to: determine that the network of validation units has reached a consensus that the transmission requested by the second message is valid; and in response to determining that the network of validation units has reached the consensus, update respective data structures by updating the balance of the first user in the respective data structures and updating at least one balance of the at least one recipient in the respective data structures.

In some embodiments, the techniques described herein relate to a system, wherein at least some of the network of validation units are configured to: receive, from the device, a validation certificate indicating that a threshold number of validation units have determined that the transmission requested by the second message is valid; and in response to receiving the validation certificate, update respective data structures by updating the balance of the first user in the respective data structures and updating at least one balance of the at least one recipient in the respective data structures

In some embodiments, the techniques described herein relate to a system, wherein the at least one computer hardware processor is further configured to: generate the first message indicating the first amount to issue to the first user by including, in the first message, information indicating a transmission of the first amount from a sender to the first user.

In some embodiments, the techniques described herein relate to a system, wherein: the at least one computer hardware processor is further configured to receive, from a device by the network of validation units, a second message requesting transmission of a second amount from the balance of the first user to the external system; and each of at least some of the network of validation units are configured to validate the transmission requested by the second message at least in part by performing: determine whether the balance of the first user is sufficient to complete the transmission of the second amount from the balance of the first user to the external system; and when it is determined that the balance of the first user is sufficient to complete the transmission of the second amount to the external system: cryptographically sign the second message with a cryptographic signature of the validation unit indicating that the transmission is valid to obtain a cryptographically signed second message; and transmit, to the device, the cryptographically signed second message.

In some embodiments, the techniques described herein relate to a non-transitory computer-readable storage medium storing instructions that, when executed by a processor, cause the processor to perform a method for updating user balances in a cryptographic transmission system based on values in an external system separate from the cryptographic transmission system, the cryptographic transmission system including a network of validation units, the network of validation units each storing a respective data structure indicating balances of a plurality of users in the cryptographic transmission system, the method including: receiving from, the external system, an indication of a first value in the external system associated with a first user of the plurality of users; determining, based on the first value in the external system associated with the first user, a first amount to issue to a balance of the first user in the cryptographic transmission system; and transmitting, to the network of validation units, a first message indicating the first amount to issue to the first user, wherein transmitting the first message causes the network of validation units to update respective data structures at least in part by adding the first amount indicated by the first message to the balance of the first user in the cryptographic transmission system.

In some embodiments, the techniques described herein relate to a cryptographic transmission system for making secure transmissions between users of the cryptographic transmission system, the cryptographic transmission system including: at least one validation unit including: memory storing, for each of a set of users, a plurality of balances of a unified transmission medium, the plurality of balances of the unified transmission medium representing amounts of different resources belonging to the user; and at least one processor configured to: receive, from a device, a request for a first transmission of a first amount of a first resource from a particular user of the set of users to a set of one or more recipients; identify, from among a plurality of balances of the unified transmission medium stored in the memory for the first user, a first balance of the unified transmission medium representing an amount of the first resource belonging to the particular user; determine whether the first balance of the unified transmission medium is sufficient to complete the first transmission of the first amount of the first resource from the particular user to the set of one or more recipients; and when it is determined that the first balance of the unified transmission medium is sufficient to complete the first transmission: sign a first message with a cryptographic signature indicating that first transmission is valid; and transmit the first message signed with the signature to the device.

In some embodiments, the techniques described herein relate to a cryptographic transmission system, wherein the at least one processor is further configured to: receive, from a device, a request for a second transmission of a second amount of a second resource from the particular user to a second set of one or more recipients; identify, from among the plurality of balances of the unified transmission medium stored in the memory for the user, a second balance of the unified transmission medium representing an amount of the second resource belonging to the particular user; determine whether the second balance of the unified transmission medium is sufficient to complete the second transmission of the second amount of the second resource from the particular user to the second set of one or more recipients; and when it is determined that the second balance of the unified transmission medium is sufficient to complete the second transmission: sign a second message with the cryptographic signature indicating that second transmission is valid; and transmit the second message signed with the cryptographic signature to the device.

In some embodiments, the techniques described herein relate to a cryptographic transmission system, wherein the at least one validation unit includes a plurality of validation units and the system further includes the device, the device configured to: receive, from the plurality of validation units, messages including validation unit signatures indicating that the first transmission is valid; and after receiving a threshold number of validation unit signatures indicating that the first transmission is valid: generate a validation message; and transmit, to the plurality of validation units, the validation message, wherein transmission of the validation message triggers execution of the first transmission.

In some embodiments, the techniques described herein relate to a cryptographic transmission system, wherein at least one processor is further configured to: in response to receiving the validation message: transmit, from the particular user to the set of one or more recipients, the first amount of the unified transmission medium.

In some embodiments, the techniques described herein relate to a cryptographic transmission system, wherein the at least one processor is further configured to: after receipt of the validation message: transmit, from the user and/or the set of one or more recipients to at least one user associated with the at least one validation unit, a particular amount of the unified transmission medium representing a particular amount of the first resource.

In some embodiments, the techniques described herein relate to a cryptographic transmission system, further including a plurality of operator units each associated with a particular one of a plurality of resources, the plurality of operator units including a first operator unit associated with the first resource, the first operator unit configured to: receive an indication of the amount of the first resource belonging to the particular user; determine an amount of the unified transmission medium representing the amount of the first resource belonging to the particular user; and transmit, to the at least one validation unit, a message to issue, to the particular user, the amount of the unified transmission medium representing the amount of the first resource belonging to the user.

In some embodiments, the techniques described herein relate to a cryptographic transmission system, wherein the at least one processor of the at least one validation unit is further configured to: receive, from the first operator unit, the message indicating the amount of the unified transmission medium to issue to the user; and in response to receiving the message indicating the amount of the unified transmission medium to issue to the user, updating the first balance of the unified transmission medium representing the amount of the first resource belonging to the particular user.

In some embodiments, the techniques described herein relate to a cryptographic transmission system, wherein the plurality of operator units include a second operator unit associated with a second resource, the second operator unit configured to: receive an indication of an amount of a second resource belonging to the particular user; determine an amount of the unified transmission medium representing the amount of the second resource belonging to the particular user; and transmit, to the at least one validation unit, a message to issue, to the particular user, the amount of the unified transmission medium representing the amount of the second resource belonging to the particular user.

In some embodiments, the techniques described herein relate to a cryptographic transmission system, wherein the at least one processor of the at least one validation unit is further configured to: receive, from the second operator unit, the message indicating the amount of the unified transmission medium to issue to the particular user; and in response to receiving the message indicating the amount of the unified transmission medium to issue to the particular user, updating a second balance of the unified transmission medium representing the amount of the second resource belonging to the particular user.

In some embodiments, the techniques described herein relate to a cryptographic transmission system, wherein the request for the first transmission includes a message indicating: one or more identifiers of one or more resources to be transmitted in the first transmission, the one or more identifiers including a first identifier of the first resource; and one or more amounts of the one or more resources to be transmitted in the first transmission, the one or more amounts including the first amount of the first resource.

In some embodiments, the techniques described herein relate to a cryptographic transmission system, wherein: the first transmission further includes a transmission of a second amount of a second resource, different from the first resource, from the particular user to the set of one or more recipients; and the at least one processor is further configured to: identify, from among the plurality of balances of the unified transmission stored in the memory for the user, a second balance of the unified transmission medium representing an amount of the second resource belonging to the user; and determine whether the second balance of the unified transmission medium is sufficient to complete the transmission of the second amount of the second resource from the particular user to the set of one or more recipients; and sign the first message with the cryptographic signature indicating that the first transmission is valid when it is determined that the second balance of the unified transmission medium is sufficient to complete the transmission of the second amount of the second resource from the particular user to the set of one or more recipients.

In some embodiments, the techniques described herein relate to a cryptographic transmission system, wherein the request for the first transmission includes: a first message from the user indicating a current nonce of the user, identifiers of the first and second resources, and amounts of the first and second resources to be transmitted by the user; and a set of one or more messages from the set of one or more recipients, each of the set of one or more messages indicating a current nonce of a respective recipient, identifiers of the first and second resources, and amounts of the first and second resources to be received by the respective recipient.

In some embodiments, the techniques described herein relate to a cryptographic transmission system, wherein the set of one more recipients includes multiple recipients and the set of one or more messages includes multiple messages.

In some embodiments, the techniques described herein relate to a cryptographic transmission system, wherein: the request for the first transmission includes a first message from the user and a set of one or more messages from the set of one or more recipients.

In some embodiments, the techniques described herein relate to a cryptographic transmission system, wherein the first message indicates: a current nonce of the user, a first resource identifier of the first resource, and the first amount of the first resource to be transmitted.

In some embodiments, the techniques described herein relate to a cryptographic transmission system, wherein each of the set of one or more messages indicates: a current nonce of a respective recipient, the first resource identifier of the first resource, and the first amount of the first resource to be received by the respective recipient.

In some embodiments, the techniques described herein relate to a method for making secure transmissions between users of a cryptographic transmission system, the cryptographic transmission system including a network of validation storing, for each of a set of users, a plurality of balances of a unified transmission medium, the method including: using at least one validation unit of the network of validation units to perform: receiving, from a device, a request for a first transmission of a first amount of a first resource from a particular user of the set of users to a set of one or more recipients; identifying, from among a plurality of balances of the unified transmission medium stored in the memory for the first user, a first balance of the unified transmission medium representing an amount of the first resource belonging to the particular user; determining whether the first balance of the unified transmission medium is sufficient to complete the first transmission of the first amount of the first resource from the particular user to the set of one or more recipients; and when it is determined that the first balance of the unified transmission medium is sufficient to complete the first transmission: signing a first message with a cryptographic signature indicating that first transmission is valid; and transmitting the first message signed with the signature to the device.

In some embodiments, the techniques described herein relate to a method, further including: receiving, from a device, a request for a second transmission of a second amount of a second resource from the particular user to a second set of one or more recipients; identifying, from among the plurality of balances of the unified transmission medium stored in the memory for the user, a second balance of the unified transmission medium representing an amount of the second resource belonging to the particular user; determining whether the second balance of the unified transmission medium is sufficient to complete the second transmission of the second amount of the second resource from the particular user to the second set of one or more recipients; and when it is determined that the second balance of the unified transmission medium is sufficient to complete the second transmission: signing a second message with the cryptographic signature indicating that second transmission is valid; and transmitting the second message signed with the cryptographic signature to the device.

In some embodiments, the techniques described herein relate to a method, wherein: the first transmission further includes a transmission of a second amount of a second resource, different from the first resource, from the particular user to the set of one or more recipients; and the method further includes: identifying, from among the plurality of balances of the unified transmission stored in the memory for the user, a second balance of the unified transmission medium representing an amount of the second resource belonging to the user; and determining whether the second balance of the unified transmission medium is sufficient to complete the transmission of the second amount of the second resource from the particular user to the set of one or more recipients; and signing the first message with the cryptographic signature indicating that the first transmission is valid when it is determined that the second balance of the unified transmission medium is sufficient to complete the transmission of the second amount of the second resource from the particular user to the set of one or more recipients.

In some embodiments, the techniques described herein relate to a non-transitory computer-readable storage medium storing instructions that, when executed by at least one processor of a network of validation units of a cryptographic transmission system, causes the at least one processor to perform a method for making secure transmissions between users of the cryptographic transmission system, the network of validation units storing, for each of a set of users, a plurality of balances of a unified transmission medium, the method including: receiving, from a device, a request for a first transmission of a first amount of a first resource from a particular user of the set of users to a set of one or more recipients; identifying, from among a plurality of balances of the unified transmission medium stored in the memory for the first user, a first balance of the unified transmission medium representing an amount of the first resource belonging to the particular user; determining whether the first balance of the unified transmission medium is sufficient to complete the first transmission of the first amount of the first resource from the particular user to the set of one or more recipients; and when it is determined that the first balance of the unified transmission medium is sufficient to complete the first transmission: signing a first message with a cryptographic signature indicating that first transmission is valid; and transmitting the first message signed with the signature to the device.

In some embodiments, the techniques described herein relate to a cryptographic transmission system for securing transmissions from senders, the cryptographic transmission system including: a network of validation units, each of at least some validation units in the network of validation units configured to: receive, from a device, a request for a transmission to at least one recipient by a sender, the request including a message from the sender requesting the transmission and at least one message from the at least one recipient requesting the transmission; validate the transmission indicated by performing: determine whether the transmission requested by the sender is valid at least in part by verifying information in the message from the sender and the at least one message from the at least one recipient; when it is determined that the transmission requested by the sender is valid, transmit, to the device, a message cryptographically signed with a validation signature indicating that the transmission is valid; receive, from the device, a validation certificate indicating that the network of validation units has validated the transmission; and in response to receiving the validation certificate, execute the transmission from the sender to the at least one recipient.

In some embodiments, the techniques described herein relate to a cryptographic transmission system, wherein verifying information in the message from the sender and the at least one message from the at least one recipient includes: verifying that a current nonce of the sender included in the message from the sender; and verifying at least one current nonce of the at least one recipient included in the at least one message.

In some embodiments, the techniques described herein relate to a cryptographic transmission system, wherein verifying information in the message from the sender and the at least one message from the at least one recipient includes: verifying that an amount of a UTM to be transmitted indicated by the message from the sender matches an amount of the UTM to be received by the at least one recipient indicated by the at least one message from the at least one recipient.

In some embodiments, the techniques described herein relate to a cryptographic transmission system, wherein verifying information in the message from the sender and the at least one message from the at least one recipient includes: verifying a cryptographic signature of the sender included in the message from the sender; and verifying at least one cryptographic signature of the at least one recipient included in the at least one message from the at least one recipient.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A cryptographic transmission system for making secure transmissions between users of the cryptographic transmission system, the cryptographic transmission system comprising:
at least one validation unit comprising:
memory storing, for each of a set of users, a plurality of balances of a unified transmission medium, the plurality of balances of the unified transmission medium representing amounts of different resources belonging to the user; and
at least one processor configured to:
receive, from a device, a request for a first transmission of a first amount of a first resource from a particular user of the set of users to a set of one or more recipients;
identify, from among a plurality of balances of the unified transmission medium stored in the memory for the first user, a first balance of the unified transmission medium representing an amount of the first resource belonging to the particular user;
determine whether the first balance of the unified transmission medium is sufficient to complete the first transmission of the first amount of the first resource from the particular user to the set of one or more recipients; and
when it is determined that the first balance of the unified transmission medium is sufficient to complete the first transmission:
sign a first message with a cryptographic signature indicating that first transmission is valid; and
transmit the first message signed with the signature to the device.

2. The cryptographic transmission system of claim 1, wherein the at least one processor is further configured to:
receive, from a device, a request for a second transmission of a second amount of a second resource from the particular user to a second set of one or more recipients;
identify, from among the plurality of balances of the unified transmission medium stored in the memory for the user, a second balance of the unified transmission medium representing an amount of the second resource belonging to the particular user;
determine whether the second balance of the unified transmission medium is sufficient to complete the second transmission of the second amount of the second resource from the particular user to the second set of one or more recipients; and
when it is determined that the second balance of the unified transmission medium is sufficient to complete the second transmission:
sign a second message with the cryptographic signature indicating that second transmission is valid; and
transmit the second message signed with the cryptographic signature to the device.

3. The cryptographic transmission system of claim 1, wherein the at least one validation unit comprises a plurality of validation units and the system further comprises the device, the device configured to:
receive, from the plurality of validation units, messages including validation unit signatures indicating that the first transmission is valid; and
after receiving a threshold number of validation unit signatures indicating that the first transmission is valid:
generate a validation message; and
transmit, to the plurality of validation units, the validation message, wherein transmission of the validation message triggers execution of the first transmission.

4. The cryptographic transmission system of claim 3, wherein at least one processor is further configured to:
in response to receiving the validation message:
transmit, from the particular user to the set of one or more recipients, the first amount of the unified transmission medium.

5. The cryptographic transmission system of claim 3, wherein the at least one processor is further configured to:
after receipt of the validation message:
transmit, from the user and/or the set of one or more recipients to at least one user associated with the at least one validation unit, a particular amount of the unified transmission medium representing a particular amount of the first resource.

6. The cryptographic transmission system of claim 1, further comprising a plurality of operator units each associated with a particular one of a plurality of resources, the plurality of operator units comprising a first operator unit associated with the first resource, the first operator unit configured to:
receive an indication of the amount of the first resource belonging to the particular user;
determine an amount of the unified transmission medium representing the amount of the first resource belonging to the particular user; and
transmit, to the at least one validation unit, a message to issue, to the particular user, the amount of the unified transmission medium representing the amount of the first resource belonging to the user.

7. The cryptographic transmission system of claim 6, wherein the at least one processor of the at least one validation unit is further configured to:
receive, from the first operator unit, the message indicating the amount of the unified transmission medium to issue to the user; and
in response to receiving the message indicating the amount of the unified transmission medium to issue to the user, updating the first balance of the unified transmission medium representing the amount of the first resource belonging to the particular user.

8. The cryptographic transmission system of claim 6, wherein the plurality of operator units comprise a second operator unit associated with a second resource, the second operator unit configured to:
receive an indication of an amount of a second resource belonging to the particular user;
determine an amount of the unified transmission medium representing the amount of the second resource belonging to the particular user; and
transmit, to the at least one validation unit, a message to issue, to the particular user, the amount of the unified transmission medium representing the amount of the second resource belonging to the particular user.

9. The cryptographic transmission system of claim 8, wherein the at least one processor of the at least one validation unit is further configured to:
receive, from the second operator unit, the message indicating the amount of the unified transmission medium to issue to the particular user; and
in response to receiving the message indicating the amount of the unified transmission medium to issue to the particular user, updating a second balance of the unified transmission medium representing the amount of the second resource belonging to the particular user.

10. The cryptographic transmission system of claim 1, wherein the request for the first transmission comprises a message indicating:
one or more identifiers of one or more resources to be transmitted in the first transmission, the one or more identifiers including a first identifier of the first resource; and
one or more amounts of the one or more resources to be transmitted in the first transmission, the one or more amounts including the first amount of the first resource.

11. The cryptographic transmission system of claim 1, wherein:
the first transmission further comprises a transmission of a second amount of a second resource, different from the first resource, from the particular user to the set of one or more recipients; and
the at least one processor is further configured to:
identify, from among the plurality of balances of the unified transmission stored in the memory for the user, a second balance of the unified transmission medium representing an amount of the second resource belonging to the user; and
determine whether the second balance of the unified transmission medium is sufficient to complete the transmission of the second amount of the second resource from the particular user to the set of one or more recipients; and
sign the first message with the cryptographic signature indicating that the first transmission is valid when it is determined that the second balance of the unified transmission medium is sufficient to complete the transmission of the second amount of the second resource from the particular user to the set of one or more recipients.

12. The cryptographic transmission system of claim 11, wherein the request for the first transmission comprises:
a first message from the user indicating a current nonce of the user, identifiers of the first and second resources, and amounts of the first and second resources to be transmitted by the user; and
a set of one or more messages from the set of one or more recipients, each of the set of one or more messages indicating a current nonce of a respective recipient, identifiers of the first and second resources, and amounts of the first and second resources to be received by the respective recipient.

13. The cryptographic transmission system of claim 12, wherein the set of one more recipients comprises multiple recipients and the set of one or more messages comprises multiple messages.

14. The cryptographic transmission system of claim 1, wherein:
the request for the first transmission comprises a first message from the user and a set of one or more messages from the set of one or more recipients.

15. The cryptographic transmission system of claim 14, wherein the first message indicates:
a current nonce of the user, a first resource identifier of the first resource, and the first amount of the first resource to be transmitted.

16. The cryptographic transmission system of claim 13, wherein each of the set of one or more messages indicates:
a current nonce of a respective recipient, the first resource identifier of the first resource, and the first amount of the first resource to be received by the respective recipient.

17. A method for making secure transmissions between users of a cryptographic transmission system, the cryptographic transmission system comprising a network of validation storing, for each of a set of users, a plurality of balances of a unified transmission medium, the method comprising:
using at least one validation unit of the network of validation units to perform:
receiving, from a device, a request for a first transmission of a first amount of a first resource from a particular user of the set of users to a set of one or more recipients;
identifying, from among a plurality of balances of the unified transmission medium stored in the memory for the first user, a first balance of the unified transmission medium representing an amount of the first resource belonging to the particular user;
determining whether the first balance of the unified transmission medium is sufficient to complete the first transmission of the first amount of the first resource from the particular user to the set of one or more recipients; and
when it is determined that the first balance of the unified transmission medium is sufficient to complete the first transmission:
signing a first message with a cryptographic signature indicating that first transmission is valid; and
transmitting the first message signed with the signature to the device.

18. The method of claim 17, further comprising:
receiving, from a device, a request for a second transmission of a second amount of a second resource from the particular user to a second set of one or more recipients;
identifying, from among the plurality of balances of the unified transmission medium stored in the memory for the user, a second balance of the unified transmission medium representing an amount of the second resource belonging to the particular user;
determining whether the second balance of the unified transmission medium is sufficient to complete the second transmission of the second amount of the second resource from the particular user to the second set of one or more recipients; and
when it is determined that the second balance of the unified transmission medium is sufficient to complete the second transmission:
signing a second message with the cryptographic signature indicating that second transmission is valid; and
transmitting the second message signed with the cryptographic signature to the device.

19. The method of claim 17, wherein:
the first transmission further comprises a transmission of a second amount of a second resource, different from the first resource, from the particular user to the set of one or more recipients; and
the method further comprises:
identifying, from among the plurality of balances of the unified transmission stored in the memory for the user, a second balance of the unified transmission medium representing an amount of the second resource belonging to the user; and
determining whether the second balance of the unified transmission medium is sufficient to complete the transmission of the second amount of the second resource from the particular user to the set of one or more recipients; and
signing the first message with the cryptographic signature indicating that the first transmission is valid when it is determined that the second balance of the unified transmission medium is sufficient to complete the transmission of the second amount of the second resource from the particular user to the set of one or more recipients.

20. A non-transitory computer-readable storage medium storing instructions that, when executed by at least one processor of a network of validation units of a cryptographic transmission system, causes the at least one processor to perform a method for making secure transmissions between users of the cryptographic transmission system, the network of validation units storing, for each of a set of users, a plurality of balances of a unified transmission medium, the method comprising:
receiving, from a device, a request for a first transmission of a first amount of a first resource from a particular user of the set of users to a set of one or more recipients;
identifying, from among a plurality of balances of the unified transmission medium stored in the memory for the first user, a first balance of the unified transmission medium representing an amount of the first resource belonging to the particular user;
determining whether the first balance of the unified transmission medium is sufficient to complete the first transmission of the first amount of the first resource from the particular user to the set of one or more recipients; and
when it is determined that the first balance of the unified transmission medium is sufficient to complete the first transmission:
signing a first message with a cryptographic signature indicating that first transmission is valid; and
transmitting the first message signed with the signature to the device.
